(19) United States
(12) Patent Application Publication
(10) Pub. No.: US 2021/0363715 A1
(43) Pub. Date: Nov. 25, 2021

(54) SYSTEMS AND METHODS FOR VEHICLE BARRIERS

(71) Applicant: Robotic Research, LLC, Clarksburg, MD (US)

(72) Inventors: William Becker, Monrovia, MD (US); Karl Nicholas Murphy, Cocoa Beach, FL (US); Steven Rotundo, Baltimore, MD (US); Alberto Daniel Lacaze, Potomac, MD (US)

(21) Appl. No.: 17/329,040

(22) Filed: May 24, 2021

Related U.S. Application Data
(60) Provisional application No. 63/028,856, filed on May 22, 2020.

(51) Int. Cl. E01F 13/04; E01F 13/12; G07C 9/10

(52) U.S. Cl. CPC E01F 13/044; G07C 9/10; E01F 13/12

(57) ABSTRACT

Systems and methods for autonomous, modular, and/or multi-segment vehicle barriers, such as portable vehicle barriers that may be automatically anchored to the ground in response to threat detection.

### CROSS-REFERENCE TO RELATED APPLICATIONS

This application claims benefit and priority under 35 U.S.C. § 119(e) to, and is a Non-provisional of, U.S. Provisional Patent Application No. 63/028856 filed on May 22, 2020 and titled “Portable Vehicle Barrier”, the contents of which are hereby incorporated by reference herein in their entirety.

### BACKGROUND

Vehicle barriers are employed in a wide-variety of locations and for various purposes requiring limited vehicle access to sensitive areas. For established and fixed facilities, barriers can be permanently installed and can be advantageously sized with ample mass to stop even the largest vehicles. For mobile and ad-hoc security and/or access control requirements, however, fixed barriers are not a feasible option (they may take weeks or months to install) and portable barriers sacrifice mass to facilitate transportation of barrier components to the mobile/ad-hoc location. Portable barriers, due their limited mass, are only capable of stopping certain classes or types of vehicles. Accordingly, a need exists for portable vehicle barriers that overcome these and other deficiencies to provide enhanced vehicle access controls for sensitive areas.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of an active vehicle barrier system according to some embodiments;

FIG. 2 is a block diagram of a system according to some embodiments;

FIG. 3 is a perspective view of a system according to some embodiments;

FIG. 4A, FIG. 4B, and FIG. 4C are side views of vehicle barriers according to some embodiments;

FIG. 5A, FIG. 5B, and FIG. 5C are side views of a vehicle barrier according to some embodiments;

FIG. 6A and FIG. 6B are perspective views of a system according to some embodiments;

FIG. 7A, FIG. 7B, and FIG. 7C are side views of a vehicle barrier according to some embodiments;

FIG. 8A and FIG. 8B are perspective views of a vehicle barrier according to some embodiments;

FIG. 9 is a flow diagram of a method according to some embodiments; and

FIG. 10 is a block diagram of an apparatus according to some embodiments.

### DETAILED DESCRIPTION

### I. Introduction

Embodiments of the present invention provide systems and methods for vehicle barriers that overcome various deficiencies and/or shortcomings of current and prior vehicle barrier systems and methods. Typical portable or transportable roadway barriers generally comprise various combinations of steel, concrete, sand, or water designed to attenuate impacts. Fitch barriers include sand-filled plastic barrels, for example, and Jersey (or K-rail) barriers are pre-cast concrete structures produced in segments sized for transport by forklift. Polyurethane barriers that can bill filled with water (to add mass) in situ provide enhanced transportability, but require a water source, are prone to leaking, and do not achieve mass levels required to stop larger vehicles.

In some embodiments described herein, portable vehicle barriers may comprise selectively actuated ground-engaging devices that are operable to greatly increase the stopping force of the portable barriers. Portable barriers in accordance with some embodiments may, for example, be activated upon detection of a threat (e.g., intentional or unintentional imminent collision with a vehicle) to automatically anchor themselves into the ground upon which they are placed. The anchoring may be triggered manually (e.g., by a guard) and/or may be effectuated automatically, e.g., in response to threat detection and/or analysis.

According to some embodiments, logic (e.g., Artificial Intelligence (AI) logic) may be utilized to (i) determine and/or identify an approaching vehicle, (ii) determine and/or identify whether a speed (and/or other parameter) of the approaching vehicle exceeds a threshold, (iii) determine and/or identify whether the approaching vehicle is authorized, (iv) determine whether a vehicle barrier should be deployed (e.g., oriented and/or engaged), and/or (v) whether ground anchoring should be employed. In some embodiments, for example, an AI and/or rules-based intelligent vehicle barrier system may autonomously determine when a threat condition exists, may automatically deploy a vehicle barrier in response to the threat, and/or may automatically anchor the barrier to the ground.

### II. Vehicle Barrier Systems

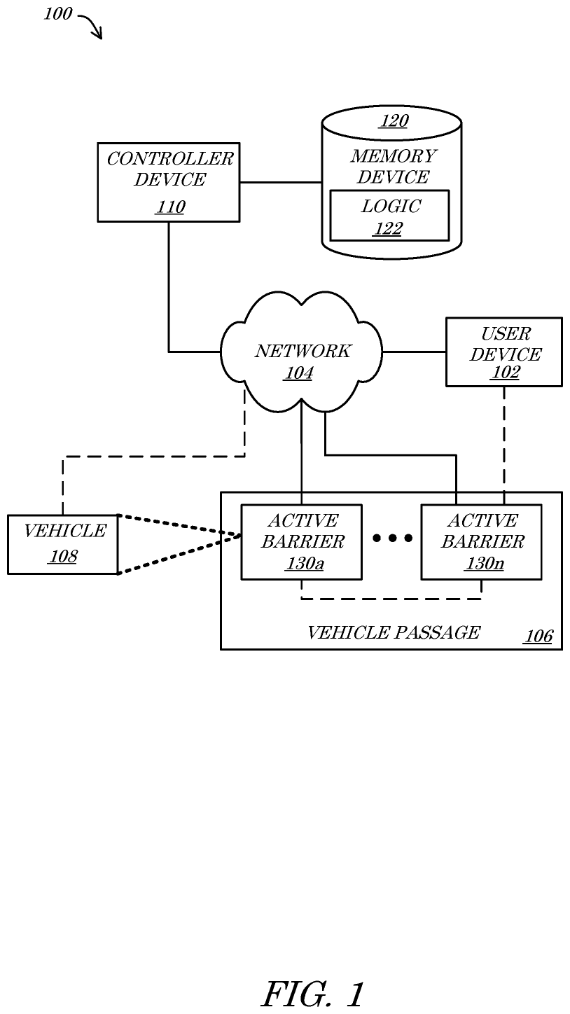

Referring initially to FIG. 1, a block diagram of an active vehicle barrier system 100 according to some embodiments is shown. In some embodiments, the system 100 may comprise a user device 102 in communication with a network 104. According to some embodiments, the system 100 may comprise a vehicle passage 106 through which a vehicle 108 is oriented to approach and/or pass through. In some embodiments, the user device 102 may be in communication with (e.g., via the network 104) a controller device 110. According to some embodiments, the controller device 110 may be in communication with a memory device 120 that stores logic 122. In some embodiments, the controller device 110 may execute the logic 122 to selectively and/or autonomously position, arm, deploy, activate, and/or otherwise control one or more active barriers 130a-n (e.g., disposed at or in the vehicle passage 106). According to some embodiments, such as in the case that the controller device 110 is disposed in proximity to and/or is integral with one or more of the active barriers 130a-n (e.g., in proximity to, at, or in the vehicle passage 106), the network 104 may not be required or may comprise only a localized network such as a set of Printed Circuit Board (PCB) traces, wires and/or cables, and/or a computerized bus.

In some embodiments, the active barriers 130a-n may be termed “active” for various reasons. The active barriers 130a-n may, for example, comprise one or more sensing capabilities such as the ability to sense and/or identify or classify the vehicle 108. According to some embodiments, the active barriers 130a-n may comprise ground-engaging features (not shown in FIG. 1) that may be selectively activated to anchor the active barriers 130a-n to a surface of the vehicle passage 106 (e.g., a road surface, bridge surface, earth, etc.). In some embodiments, the controller device 110 may be operable to receive data from the active barriers 130a-n and/or the user device 102 and, based at least in part on the received data, trigger the active barriers 130a-n to deploy and/or activate one or more anchoring mechanisms thereof. According to some embodiments, a detection, identification, and/or classification of the vehicle 108 may cause the controller device 110 (e.g., by execution of the logic 122 and/or a portion thereof) to send a signal to the active barriers 130a-n to cause activation thereof. In some embodiments, any or all of the devices 102, 110, 130a-n may comprise and/or be in communication with the memory device 120. The memory device 120 may store and/or the logic 122 may comprise, for example, one or more Artificial Intelligence (AI), Machine Learning (ML), rules-based, binary tree, and/or other logical instructions (e.g., sets of logic, rules, and/or 0thresholds) that, when executed by the controller device 110 cause the selective activation and/or control of the active barriers 130a-n.

According to some embodiments, as depicted in FIG. 1, any or all of the devices 102, 110, 130a-n, 120 (or any combinations thereof) may be in communication via the network 104. In some embodiments, communications between and/or within the devices 102, 110, 130a-n, 120 of the system 100 may be utilized to manage and/or control the active barriers 130a-n to govern access to and/or through the vehicle passage 106. The controller device 110 (and/or the user device 102) may identify, detect, and/or derive an indication of an existence and/or location of the vehicle 108 in relation to the vehicle passage 106, based on input received from the active barriers 130a-n (and/or from the user device 102), for example, by execution of the logic 122 stored in the memory device 120. According to some embodiments, such indication may be calculated, looked up, derived, defined, computed, and/or otherwise determined by analysis of imagery or other data captured by the user device 102 and/or the active barriers 130a-n (and/or from a third-party source; not shown) pursuant to an execution of the logic 122 defined by the controller device 110.

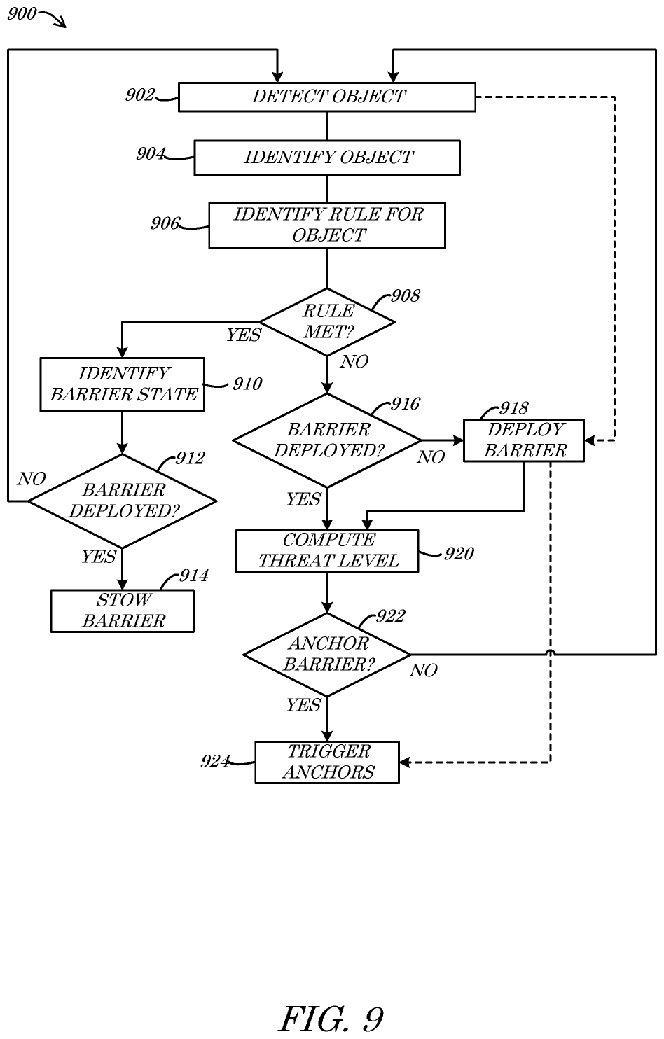

Fewer or more components 102, 104, 106, 108, 110, 120, 122, 130a-n and/or various configurations of the depicted components 102, 104, 106, 108, 110, 120, 122, 130a-n may be included in the system 100 without deviating from the scope of embodiments described herein. In some embodiments, the components 102, 104, 106, 108, 110, 120, 122, 130a-n may be similar in configuration and/or functionality to similarly named and/or numbered components as described herein. In some embodiments, the system 100 (and/or portion thereof) may comprise an autonomous vehicle barrier deployment and/or activation system and/or platform programmed and/or otherwise configured to execute, conduct, and/or facilitate the method 900 of FIG. 9 herein, and/or portions thereof.

The user device 102, in some embodiments, may comprise any type or configuration of computing, mobile electronic, network, user, and/or communication device that is or becomes known or practicable. The user device 102 may, for example, comprise one or more tablet computers, such as an iPad® manufactured by Apple®, Inc. of Cupertino, Calif., and/or cellular and/or wireless telephones or “smart” phones, such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. In some embodiments, the user device 102 may comprise one or more devices owned and/or operated by one or more users, such as a guard, security personnel, soldier, etc. According to some embodiments, the user device 102 may communicate with the controller device 110 via the network 104 to provide and/or receive information descriptive of the vehicle passage 106, the vehicle 108, and/or the active barriers 130a-n. According to some embodiments, the user device 102 may store and/or execute specially programmed instructions (such as a mobile device application) to operate in accordance with embodiments described herein. The user device 102 may, for example, execute one or more mobile device programs that activate and/or control the active barriers 130a-n, e.g., to detect and/or identify the vehicle 108, identify one or more rules associated with the vehicle 108, evaluate the one or more rules, and/or trigger the active barriers 130a-n (e.g., directly or via the controller 110) based on the evaluation of the rules.

In some embodiments, the network 104 may comprise a Local Area Network (LAN; wireless and/or wired), cellular telephone, Bluetooth®, Near Field Communication (NFC), and/or Radio Frequency (RF) network with communication links between the controller device 110, the user device 102, the vehicle 108, the active barriers 130a-n, and/or the memory device 120. In some embodiments, the network 104 may comprise direct communication links between any or all of the components 102, 108, 110, 120, 130a-n of the system 100. The active barriers 130a-n may, for example, be directly interfaced or connected to one or more of the controller device 110 and/or the user device 102 via one or more wires, cables, wireless links, and/or other network components, such network components (e.g., communication links) comprising portions of the network 104. In some embodiments, the network 104 may comprise one or many other links or network components other than those depicted in FIG. 1. The controller device 110 may, for example, be connected to user device 102 via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102, 110, 130a-n, 120 of the system 100. The network 104 may comprise one or more cellular telephone networks with communication links between the vehicle 108 and the controller device 110, for example, and/or may comprise an NFC or other short-range wireless communication path, with communication links between the user device 102, the controller device 110, and/or one or more of the active barriers 130a-n, for example.

According to some embodiments, the vehicle passage 106 may comprise any type, quantity, and/or configuration of passage, path, channel, and/or course navigable by the vehicle 108. The vehicle passage 106 may comprise, for example, a roadway, an entry gate passage, a tunnel, a bridge, a waterway, a taxiway, and/or any distinct path for which governed access is desired. The vehicle passage 106 may comprise various surfaces over which the vehicle 108 may travel and/or upon which the active barriers 130a-n may be placed. In the case that the vehicle passage 106 comprises a permanent and/or improved roadway, the surface may comprise asphalt, concrete, paving stones, brick, and/or other installed surface materials. In the case that vehicle passage 106 comprises a temporary and/or unimproved roadway, the surface may comprise clay, dirt, aggregate (loose or compacted), sand, and/or mud.

In some embodiments, the vehicle 108 may comprise any type, configuration, and/or quantity of vehicles. According to some embodiments, the vehicle 108 may be simply identified as a moving object and/or an object having a particular size, shape, estimated mass, velocity, acceleration, etc. In some embodiments, the vehicle 108 may be classified based on one or more characteristics thereof and/or may be identified. The vehicle 108 may comprise a particular make, model, and/or type of vehicle, for example, and/or may be uniquely identifiable utilizing one or more codes, numbers, and/or identifiers (human and/or machine-readable). In some embodiments, the vehicle 108 may approach the vehicle passage 106 in an attempt to pass therethrough and the other components of the system 100 may selectively deploy and/or control the active barriers 130a-n based on one or more characteristics of the vehicle 108 (alone or in combination with other data such as time of day).

According to some embodiments, the controller device 110 may comprise an electronic and/or computerized controller device, such as a computer server communicatively coupled to interface with the active barriers 130a-n (directly and/or indirectly). The controller device 110 may, for example, comprise one or more PowerEdge™ R830 rack servers manufactured by Dell®, Inc. of Round Rock, Tex. which may include one or more Twelve-Core Intel® Xeon® E5-4640 v4 electronic processing devices. In some embodiments, the controller device 110 may comprise a plurality of processing devices specially programmed to execute and/or conduct processes that are not practicable without the aid of the controller device 110. The controller device 110 may, for example, execute one or more coded rules (e.g., the logic 122) to autonomously control the active barriers 130a-n, which may not be capable of being conducted without the benefit of the specially-programmed controller device 110. According to some embodiments, the controller device 110 may be located remotely from one or more of the user device 102 and/or the active barriers 130a-n (and the vehicle passage 106). The controller device 110 may also or alternatively comprise a plurality of electronic processing devices located at one or more various sites and/or locations (e.g., the vehicle passage 106 and/or other locations, not shown) and/or may be integrated with one or more of the active barriers 130a-n.

According to some embodiments, the controller device 110 may store and/or execute specially programmed instructions (e.g., stored in the memory device 120, such as the logic 122) to operate in accordance with embodiments described herein. The controller device 110 may, for example, execute one or more programs, modules, and/or routines (e.g., the logic 122) that facilitate the autonomous control of the active barriers 130a-n, as described herein. According to some embodiments, the controller device 110 may comprise a computerized processing device, such as a server (centralized or in situ) utilized, for example, to (i) receive and/or identify data descriptive of the vehicle 108 and/or of the active barriers 130a-n, e.g., from the user device 102, the vehicle 108, and/or the active barriers 130a-n, (ii) identify correlations between portions of received data and/or sensor readings and stored and/or learned object recognition and/or classification data, (iii) identify the vehicle 108, (iv) classify the vehicle 108, (v) identify an active barrier 130a-n deployment trigger, (vi) identify an active barrier 130a-n deployment exception, (vii) trigger a deployment of the active barriers 130a-n, and/or (viii) trigger an anchoring of the active barriers 130a-n, as described herein.

In some embodiments, the memory device 120 may comprise various databases and/or data storage mediums that may store, for example, image (and/or other sensor) data, object identification rules, object and/or material data, vehicle data, active barrier 130a-n data, location data, cryptographic keys and/or data, login and/or identity credentials, and/or instructions (e.g., autonomous vehicle barrier control instructions and/or guidance, such as exemplified by the logic 122) that cause various devices (e.g., the active barriers 130a-n) to operate in accordance with embodiments described herein.

The memory device 120 may store, for example, the logic 122, which may, when executed, facilitate and/or cause autonomous and/or “active” protection of the vehicle passage 106, as described herein. In some embodiments, the memory device 120 may comprise any type, configuration, and/or quantity of data storage devices that are or become known or practicable. The memory device 120 may, for example, comprise an array of optical and/or solid-state hard drives configured to store digital image and/or video data, image and/or object analysis data and/or location and/or object analysis data (e.g., analysis formulas and/or mathematical models), credentialing instructions and/or keys, and/or various operating instructions, drivers, etc. While the memory device 120 is depicted as a single stand-alone component of the controller device 110, the memory device 120 may comprise multiple components. In some embodiments, a multi-component memory device 120 may be distributed across various devices and/or may comprise remotely dispersed components. Any or all of the user device 102, the vehicle 108, the active barriers 130a-n, and/or the controller device 110 may comprise the memory device 120 or a portion thereof, for example.

In some embodiments, the active barriers 130a-n may comprise various components (not shown in FIG. 1) that permit the active barriers 130a-n to detect and/or identify the vehicle 108, reposition, absorb an impact by the vehicle 108, automatically anchor into the ground or surface of the vehicle passage 106, stop the vehicle 108, and/or reposition to permit passage of the vehicle 108. Examples of different configurations of active barriers 130a-n in accordance with some embodiments are described herein.

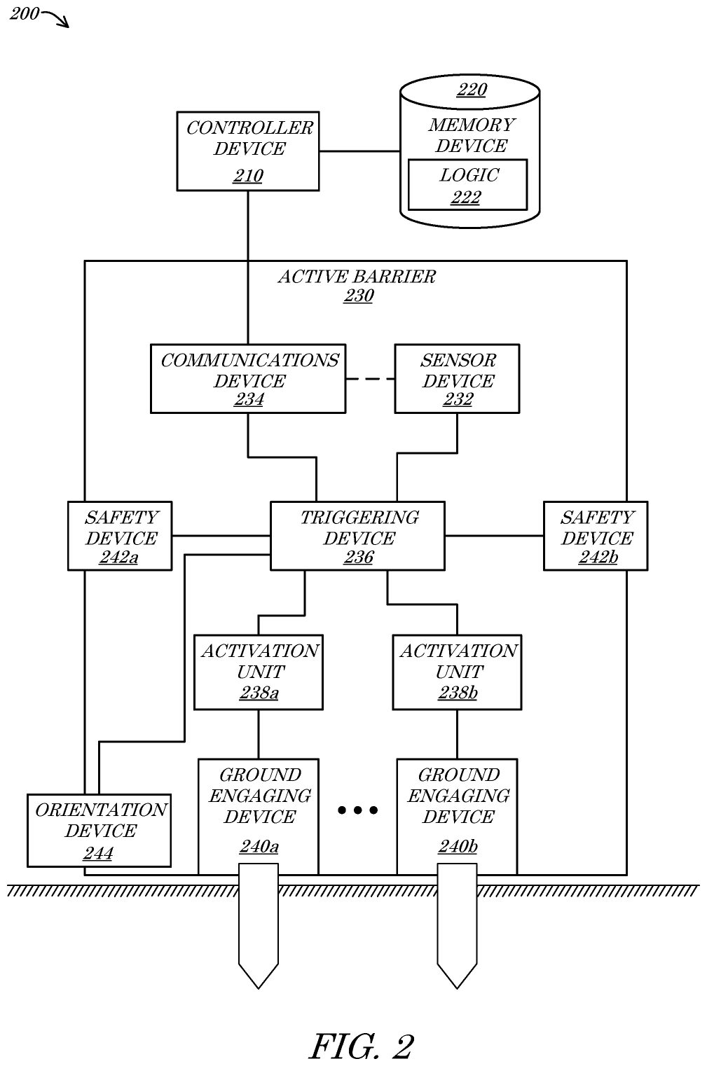

Turning to FIG. 2, for example, a block diagram of a system 200 according to some embodiments is shown. According to some embodiments, the system 200 may be similar in configuration and/or functionality to the system 100 of FIG. 1 and/or one or more components thereof (e.g., the active barriers 130a-n and/or the controller 110). In some embodiments, the system 100 may comprise a controller device 210 in communication with a memory device 220 storing various instructions such as logic 222. According to some embodiments, the system 200 may comprise one or more vehicle barriers and/or barricades such as an active barrier 230. In some embodiments, the active barrier 230 may comprise a sensor device 232, a communications device 234, a triggering device 236, and/or one or more activation units 238a-b coupled to selectively drive corresponding ground engaging devices 240a-b into the surface upon which the active barrier 230 is disposed. According to some embodiments, the active barrier 230 may comprise one or more safety devices 242a-b coupled to prevent accidental triggering of the activation units 238a-b (e.g., by being interfaced with the triggering device 236). In some embodiments, the system 200 and/or the active barrier 230 may comprise an orientation device 244 that is coupled to position or reposition the active barrier 230.

In some embodiments, the controller device 210 may be operable to execute stored instructions (e.g., the logic 222) to selectively control, command, and/or interface with the various devices 232, 234, 236, 238a-b, 240a-b, 242a-b, 244. According to some embodiments, the logic 222 may cause and/or direct the controller device 210 to monitor the sensor device 232 to identify a trigger condition and/or to activate the sensor device 232. Other devices (such as a clock—not shown) may be communicated with and/or monitored to identify triggering conditions. According to some embodiments, the sensor device 232 may be directly interfaced with the triggering device 236. The sensor device 232, upon detection and/or sensing of an event and/or data reading may, for example, send a signal to the triggering device 236. In such embodiments the controller 210 device may not be needed or may be bypassed. In the case that the sensor device 232 comprises multiple sensors (not separately shown), one or more sensors may automatically activate the triggering device 236 upon detection or sensing of a reading exceeding a threshold, for example, while other sensors may send data to the controller 210 for evaluation (e.g., via the communications device 234) prior to the controller 210 selectively activating the triggering device 236. In some embodiments, the sensor device 232 may acquire data descriptive of an area or location (not shown) and such data may be provided to the controller 210.

According to some embodiments, the data received at the controller device 210 from the sensor 232 may be descriptive of an object (not shown in FIG. 2). In accordance with the logic 222 (and/or other instructions), the controller device 210 may analyze the data to identify the object, classify the object, and/or locate (or track) the object. The controller device 210 may, by execution of the logic 222 (and/or other instructions), for example, identify the object as an approaching vehicle. According to some embodiments, the controller device 210 may execute instructions that result in an evaluation of the object with respect to stored rules and/or thresholds. In the case of an approaching vehicle, for example, the controller device 210 may determine that the vehicle is unauthorized (e.g., based on an identify of the vehicle) and/or that a characteristic of the vehicle (e.g., size, color, speed, acceleration, movement) falls outside of acceptable parameter thresholds. In such a case, the logic 222 may direct the controller device 210 to activate the triggering device 236 to trigger the activation units 238a-b (or a selective subset of the activation units 238a-b) to drive the ground engaging devices 240a-b into the ground/surface, e.g., anchoring the active barrier 230 to the ground/surface. The triggering device 236, upon activation by the controller device 210 for example, may send a signal to one or more of the activation units 238a-b that causes the activation units 238a-b to exert a driving force that forces the ground engaging devices 240a-b into the ground/surface. According to some embodiments, the triggering device 236 may comprise a relay, circuit, and/or power source and/or the activation units 238a-b may comprise one or more charges (e.g., explosives), springs, pneumatic, and/or hydraulic force application devices, mechanical force application devices, and/or firing or combustion chambers. In some embodiments, the controller device 210 may execute the logic 222 (and/or other instructions) to control access to an area, e.g., based on the identification and/or classification of sensed objects.

In some embodiments, triggering and/or initiation of the activation units 238a-b may be prevented upon detection and/or identification of an exception. The controller device 210 may execute the logic 222 to determine, for example, that even though the approaching vehicle is not authorized, an exception exists that should prevent activation of the ground engaging devices 240a-b. In some embodiments, the exception may occur outside of the logical and/or rules-based analysis of the controller device 210. The controller device 210 may send a triggering or activation signal (e.g., via the communications device 234), for example, but the triggering device 236 may be prevented (e.g., mechanically and/or electrically) from forwarding the signal to and/or from otherwise triggering the activations units 238a-b. In the case that the safety devices 242a-b have not been disengaged, for example, the triggering device 236 may not be capable of triggering the activation units 238a-b (i.e., they may be “unarmed” or “disarmed”). In some embodiments, in the case that the safety devices 242a-b have been removed, turned off, and/or otherwise disengaged, the triggering device 236 may become capable of triggering the activation units 238a-b (i.e., they may be “armed”).

According to some embodiments, the orientation device 244 may be selectively controlled and/or activated by the controller device 210. The orientation device 244 may comprise a motor, hydraulic piston, explosive charge, and/or mechanical movement device, for example, that is coupled to the active barrier 210. In some embodiments, the orientation device 244 may be operable to move the active barrier 230 from a first position and/or orientation to a second position and/or orientation. Various positions and/or orientations of the active barrier 230 may, for example, be selectively acquired by the controller device 210 sending signals to the orientation device 244 in response to data received from the sensor device 232. Depending upon the classification and/or evaluation of an approaching vehicle, for example, the orientation device 244 may be utilized to position and/or orient the active barrier 230 in a desired manner. In the case that the vehicle is determined to be authorized and the active barrier 230 is currently in a “deployed” state (e.g., a first position and/or orientation), for example, the controller device 210 may send a command to the orientation device 244 to reorient the active barrier 230 (or a portion thereof) to a “stowed” state (e.g., a second position and/or orientation).

In some embodiments, the controller device 210 may be in communication with the active barrier 230 and positioned either remotely (e.g., in which case the communications device 234 may comprises a wireless communication device) therefrom or in proximity thereto (e.g., in which case the communications device 234 may comprises a wire or cable). According to some embodiments, the controller device 210 and/or the memory device 222 may be coupled to and/or integrated into the active barrier 230. The active barrier 230 may comprise a barrier (e.g., concrete and/or steel) for stopping vehicles, for example, that is outfitted with an electronics package comprising any or all of the controller device 210, the memory device 220, the sensor 232, the communications device 234, the triggering device 236, the activation units 238a-b, and/or the orientation device 244.

In some embodiments, fewer or more components 210, 220, 222, 230, 232, 234, 236, 238a-b, 240a-b, 242a0b, 244 and/or various configurations of the depicted components 210, 220, 222, 230, 232, 234, 236, 238a-b, 240a-b, 242a-b, 244 may be included in the system 200 without deviating from the scope of embodiments described herein. In some embodiments, the components 210, 220, 222, 230, 232, 234, 236, 238a-b, 240a-b, 242a0b, 244 may be similar in configuration and/or functionality to similarly named and/or numbered components as described herein. In some embodiments, the system 200 (and/or portion thereof) may comprise an autonomous vehicle barrier deployment and/or activation system and/or platform programmed and/or otherwise configured to execute, conduct, and/or facilitate the method 900 of FIG. 9 herein, and/or portions thereof.

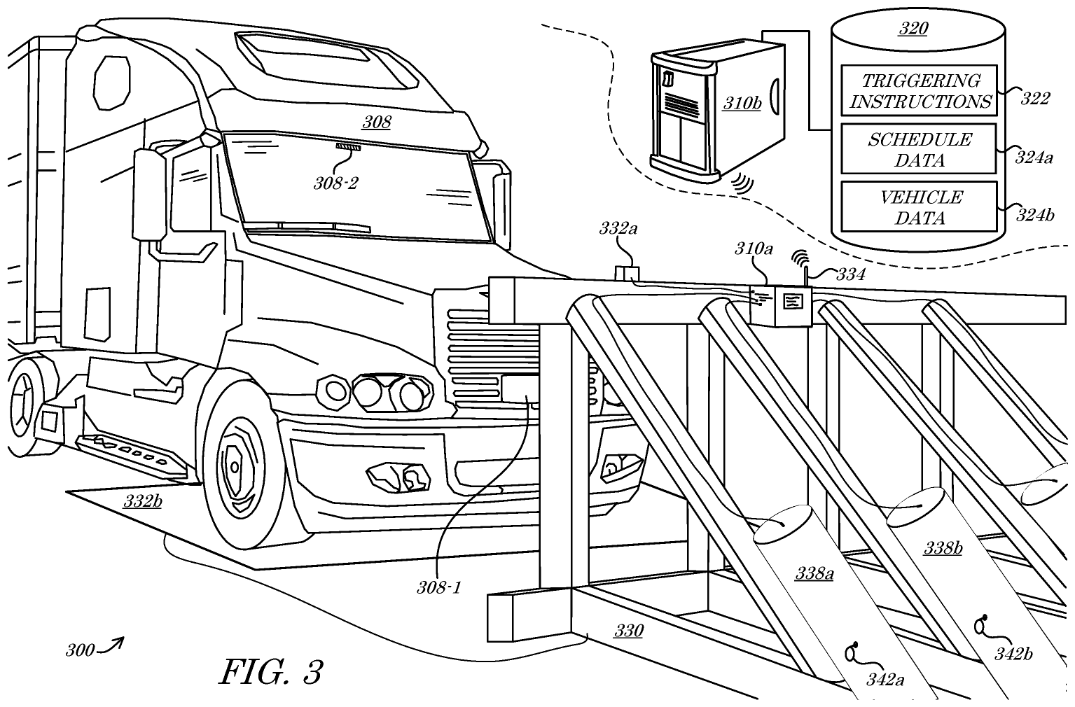

Referring now to FIG. 3, a perspective view of a system 300 according to some embodiments is shown. In some embodiments, the system 300 may be similar in configuration and/or functionality to the systems 100, 200 of FIG. 1 and/or FIG. 2 herein. The system 300 may comprise, for example, a vehicle 308 comprising one or more identifiers 308-1, 308-2, one or more controller devices 310a-b, and/or a memory 322 storing triggering instructions 322 and data 324a-b. In some embodiments, the system 300 may comprise an active barrier 330, e.g., disposed in a path of the vehicle 308. According to some embodiments, the active barrier 330 may comprise and/or be in communication with one or more sensors 332a-b, a communication device 334, and/or a plurality of activation units 338a-b. In some embodiments, each activation unit 338a-b may comprise a dedicated safety device 342a-b, e.g., safety pins as depicted in FIG. 3.

According to some embodiments, information descriptive of the vehicle 308 may be provided to one or more of the controller devices 310a-b and one or more of the controller devices 310a-b may, in response to the data, selectively trigger the activation units 338a-b and thereby anchor the active barrier 330 to the ground. In some embodiments, the activation units 338a-b may be triggered based on (i) locally processed data, (ii) remotely processed data, or (iii) a combination thereof. A local or first controller device 310a may, for example, receive data from one or more of a first sensor 332a and a second sensor 332b. In some embodiments, such data may automatically cause the first controller device 310a to trigger the activation units 338a-b. The first controller device 310a may be programmed, for example, to automatically anchor the active barrier 330 into the ground upon detection, identification, and/or classification of the vehicle 308. The first controller device 310a may evaluate the received data utilizing stored rules to determine whether the presence, movement, characteristics, and/or identity of the vehicle fall outside of acceptable thresholds. In the case that the presence of the vehicle 308 (e.g., no vehicles are permitted near the active barrier 330), a characteristic of the vehicle 308 (e.g., the vehicle 308 is larger than a permitted size), a movement of the vehicle 308 (e.g., the speed of the vehicle is above a threshold approach speed and/or the vehicle 308 is determined to be travelling in an erratic fashion; which may be considered a characteristic of the vehicle 308 in some embodiments), and/or an identify of the vehicle 308 (e.g., a license plate or other official and/or human-readable identifier 308-1 is not on a list of approved identifiers) fail to meet stored threshold and/or rule criteria, the first controller device 310a may send a signal to the activation units 338a-b (or a selected one or subset of the activation units 338a-b) that causes the activation units 338a-b to anchor the active barrier 330 into the ground. According to some embodiments, the safety devices 342a-b must be removed in order for the activation units 338a-b to be enabled to be responsive to the signal transmitted by the first controller device 310a (e.g., they must be “armed” prior to triggering).

In some embodiments, the first sensor 332a may comprise a Light Detection and Ranging (LiDAR), Infrared Radiation (IR), Passive IR (PIR), radar, camera, stereo camera, 3D-camera, ultrasonic, acoustic, pressure, weight, temperature, and/or other sensor device and/or combinations thereof, in some embodiments, and may detect, monitor, analyze, track, and/or map movements of the vehicle 308 (e.g., as the vehicle 308 approaches the active barrier 330) and/or detect and/or measure an impact of the vehicle 308 with the active barrier 330. According to some embodiments, the first sensor 332a may capture images and/or video of the vehicle 308 and the first controller device 310a may execute object recognition and/or classification processing to identify the vehicle 308 from the video/images and/or classify the vehicle 308 based on a comparison to stored object classification data. In some embodiments, the first controller device 310a may identify the human-readable identifier 308-1 of the vehicle 308 utilizing character recognition logic. According to some embodiments, the vehicle 308 may transmit an indication of a machine-readable identifier 308-2 (and/or location and/or telemetry data) to the first controller device 310a. In some embodiments, the second sensor 332b may comprise a pressure pad, inductive loop sensor, a switch or button, and/or a simple pneumatic tube. The second sensor 332b may, for example, be disposed in a pathway proximate to the active barrier 330 such that a presence of the vehicle 308 may be detected prior to the vehicle 308 arriving at (and/or impacting) the active barrier 330. In some embodiments, the second sensor 332b may be positioned more distal from the active barrier 330, such as fifty meters (50 m) or one hundred meters (100 m) from the active barrier 330, e.g., to provide more advanced warning in the case of higher-speed approaches to the active barrier 330.

According to some embodiments, any or all of the data acquired by the sensors 332a-b may be processed by the first controller device 310a to selectively trigger the activation units 338a-b and/or may be transmitted to a remote and/or second controller device 310b (e.g., via the communication device 334). The first controller device 310a may comprise a binary triggering device, for example, that performs little or no logical evaluation but simply triggers the active barrier 330 upon receipt of signal from one or more of the sensors 332a-b. In the case that the first sensor 332a comprises an impact sensor, for example, upon detection of an impact by the vehicle 308 the first controller device 310a may automatically trigger the activation units 338a-b. In some embodiments, the activation units 338a-b may also or alternatively be triggered based on signals received by the first controller device 310a (and/or by the communication device 310b thereof). The second controller device 310b may be in communication with and/or have access to the memory 322 storing the triggering instructions 322 and data 324a-b, for example, and may execute the triggering instructions 322 to process the data 324a-b, e.g., in comparison to data received from the active barrier 330 and/or from the vehicle 308. The vehicle 308 may transmit one or more of the identifiers 308-1, 308-2 to the second controller device 310b and/or the first controller device 310a may transmit any or all sensor data received from the sensors 332a-b to the second controller device 310b. The second controller device 310b may then, for example (e.g., in response to the receiving of data), execute the triggering instructions 322 to identify and/or determine whether the active barrier 330 should be anchored (e.g., triggered).

In some embodiments, the triggering instructions 322 may cause the second controller device 310b to compare data descriptive of the vehicle 308 such as one or more of the identifiers 308-1, 308-2, a size, color, shape, weight, mass, speed, acceleration, trajectory, and/or location to stored vehicle data 324b. The triggering instructions 322 may be programmed with various thresholds and/or rules, for example, that permit certain vehicles 308 to approach and/or pass the active barrier 330 and that identify alarm or threat conditions in the cases that the vehicle 308 does not meet one or more of the stored thresholds and/or rules. Alarm/threat conditions may be transmitted to the active barrier 330 to cause the active barrier 330 to deploy, move (e.g., in the case that the active barrier 330 comprises movement mechanisms; not shown in FIG. 3), and/or perform an anchoring action (e.g., triggering the activation units 338a-b. According to some embodiments, the evaluation of the threat level for the vehicle 308 may consider other data such as time of day, weather, threat and/or readiness levels or settings, etc. The second controller device 310b may execute the triggering instructions 322 to evaluate both the vehicle data 324b and schedule data 324a, for example, such that the vehicle 308 may trigger a threat in the case that the vehicle 308 is authorized based on size, shape, type, and/or identity but has arrived at the active barrier 330 outside of an authorized time.

According to some embodiments, the processing and/or evaluation of data from the sensors 332a-b, the vehicle 308, and/or other sources (not shown; e.g., the schedule data 324a) may be conducted by either or both of the controller devices 310a-b and may occur at the active barrier 330 and/or remote therefrom. In some embodiments, the memory 320 may be stored locally and/or remotely and the triggering instructions 322 may accordingly be executed by either or both of the controller devices 310a-b. According to some embodiments, the activation units 338a-b may be selectively and/or individually triggered in response to an identification of a threat condition. Threats of a certain or first computed magnitude such as a smaller vehicle 308 (e.g., having a size that falls below a size and/or mass threshold) and/or a vehicle 308 travelling at a slower speed (e.g., having a measured speed that falls below a speed threshold) may correspond to a triggering of only a first activation unit 338a, for example, while threats of a second computed magnitude may correspond to a triggering a plurality of activation units 338a-b. In some embodiments, the different activation units 338a-b may comprise different configurations and may be selected based on their configurations. The first activation unit 338a may be configured and/or outfitted to drive a carbon fiber spike (not shown in FIG. 3) into the ground, for example, while a second activation unit 338b may be configured and/or outfitted to drive an anchoring cable (not shown in FIG. 3) into the ground. These and other different ground-engaging devices may be selected for triggering based on characteristics of the computed threat. In other words, the quantity and/or type of activation units 338a-b triggered by the controller devices 310a-b may be computed and/or selected based on the data received from the sensors 332a-b and/or from the vehicle 308.

In some embodiments, fewer or more components 308, 308-1, 308-2, 310a-b, 320, 322, 324a-b, 330, 332a-b, 334, 338a-b, 342a-b and/or various configurations of the depicted components 308, 308-1, 308-2, 310a-b, 320, 322, 324a-b, 330, 332a-b, 334, 338a-b, 342a-b may be included in the system 300 without deviating from the scope of embodiments described herein. In some embodiments, the components 308, 308-1, 308-2, 310a-b, 320, 322, 324a-b, 330, 332a-b, 334, 338a-b, 342a-b may be similar in configuration and/or functionality to similarly named and/or numbered components as described herein. In some embodiments, the system 300 (and/or portion thereof) may comprise an autonomous vehicle barrier deployment and/or activation system and/or platform programmed and/or otherwise configured to execute, conduct, and/or facilitate the method 900 of FIG. 9 herein, and/or portions thereof.

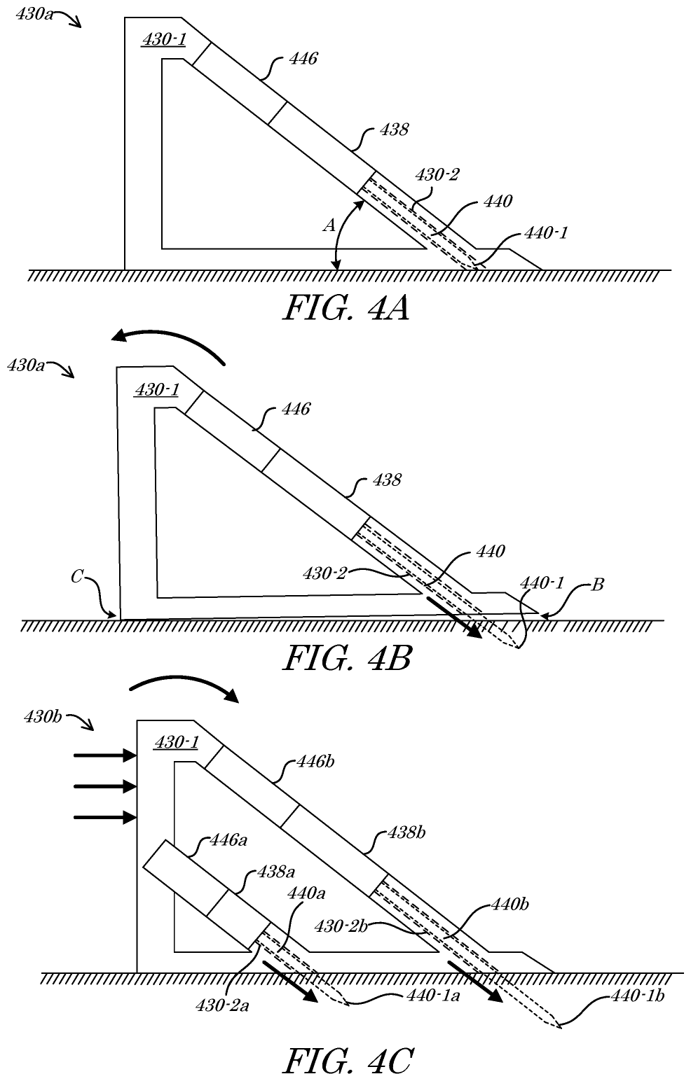

Turning now to FIG. 4A, FIG. 4B, and FIG. 4C, side views of vehicle barriers 430a-b according to some embodiments are shown. The shape and configuration of the vehicle barriers 430a-b is depicted for purposes of non-limiting example, only. The vehicle barriers 430a-b may comprise various shapes, sizes, and/or configurations according to some embodiments. While both a first vehicle barrier 430a (FIG. 4A and FIG. 4B) and a second vehicle barrier 430b (FIG. 4C) are depicted, because they are presented with many identical or similar components, reference may be generally made solely to the first vehicle barrier 430a with respect to such common and/or similar components, for ease of explanation. In some embodiments, the first vehicle barriers 430a may comprise a body or frame 430-1 within which is disposed a bore 430-2. According to some embodiments, the bore 430-2 may be oriented toward the ground/surface upon which the first vehicle barrier 430a is disposed. As depicted in FIG. 4A, the bore 430-2 may be oriented at an angle “A” with respect to the ground/surface. While the angle “A” may be configured at various desired increments, e.g., based on the types of vehicles (not shown) and/or threats for which the first vehicle barrier 430a is designed, as depicted in FIG. 4A, FIG. 4B, and FIG. 4C, the angle “A” may in some embodiments be within the range of thirty degrees (30°) to seventy-five degrees (75°). According to some embodiments, the angle “A” may be selectively variable, such as in the case that the orientation of the first vehicle barrier 430a and/or the bore 430-2 thereof may be adjusted.

In some embodiments, and as depicted in FIG. 4A, an activation unit 438 may be coupled to and/or aligned with the bore 430-2 such that it may act upon a ground engaging deice 440 disposed and/or housed within the bore 430-2. The activation unit 438 may comprise an explosive charge, for example, that is coupled to drive the ground engaging deice 440 through the bore 430-2 and into the ground/surface. As depicted, the ground engaging device 440 may comprise a tip 440-1 to facilitate penetration of the ground engaging device 440 into the ground/surface. The ground engaging device 440 may comprise, for example, a metal (e.g., steel) and/or composite rod with the tip 440-1 oriented in the bore 430-2 toward the ground/surface. While the tip 440-1 is depicted for purposes of non-limiting example as a simple beveled end, in some embodiments, the tip 440-1 may comprise various configurations appropriate for various surface types such as fluted and/or sharpened tips, expanding tips, barbed tips, and/or anchoring tips (e.g., tips comprising post-impact deployed spikes, barbs, hooks, etc.). In some embodiments, the tip 440-1 may comprise an anchoring tip that deploys one or more lateral projections upon penetration and the ground engaging deice 440 may comprise a cable or tether coupled to the activation unit 438, the bore 430-2, and/or the frame 430-1. As depicted in FIG. 4A, the first vehicle barrier 430a may be disposed in a first state at a first time, such as a state of rest and/or inactivation. The first vehicle barrier 430a may rest passively on the ground/surface, for example, until the activation unit 438 is triggered (e.g., upon detection of a threat condition) as described herein. As depicted in FIG. 4A, at the first time and/or in the first state, the tip 440-1 of the ground engaging deice 440 may be disposed within the bore 430-2, e.g., in an undeployed or stowage state.

According to some embodiments, upon triggering of the activation unit 438 (e.g., in response to a threat such as an unauthorized vehicle approaching at high speed and/or a detected impact), and as depicted in FIG. 4B, the activation unit 438 may drive the tip 440-1 of the ground engaging device 440 from the bore 430-1 and into the ground/surface. In some embodiments, the mass of the frame 430-1 may counteract the driving force to maintain the first vehicle barrier 430a at the original location and/or orientation. According to some embodiments, the first vehicle barrier 430a may comprise a mass 446 (e.g., a tamping mass) disposed and/or coupled to counteract the driving force to, e.g., permit the ground engaging device 440 to be driven more effectively into the ground/surface. In some embodiments, and as depicted in FIG. 4B, the driving force exerted by the activation unit 438 may cause a trailing edge of the first vehicle barrier 430a to raise from the ground/surface at “B”, e.g., as the ground engaging device 440 is driven into contact with the ground/surface in accordance with the linear directional arrow as shown. According to some embodiments, the raising at “B” may cause the first vehicle barrier 430a to rotate forward as depicted by the rotational directional arrow in FIG. 4B and/or a leading edge of the first vehicle barrier 430a may exert force upon and/or penetrate the ground/surface at “C”. As depicted in FIG. 4B, the first vehicle barrier 430a may be disposed in a second state at a second time, such as a state of activation and/or ground-engagement (e.g., anchoring). According to some embodiments, the activation unit 438 may comprise mechanical linkage coupled to the frame 430-1 and/or a force plate (not shown), either of which may translate an impact force through the linkage to drive the ground engaging device 440 into the ground.

In some embodiments, and as depicted in FIG. 4C, the second vehicle barrier 430b (which may, in some embodiments, comprise the first vehicle barrier 430a at a third state and/or at a third time) may be disposed in the third state at the third time, such as a state of impact (as indicated by the horizontal linear directional arrows in FIG. 4C acting upon a leading face of the frame 430-1). According to some embodiments, the second vehicle barrier 430b may comprise a first bore 430-2a and a second bote 430-2b, where the second bore 430-2b may be similar or equivalent to the bore 430-2 of the first vehicle barrier 430a. In some embodiments, the second vehicle barrier 430b may comprise a first activation unit 438a and a second activation unit 438b, where the second activation unit 438b may be similar or equivalent to the activation unit 438 of the first vehicle barrier 430a. According to some embodiments, the second vehicle barrier 430b may comprise a first ground engaging device 440a and a second ground engaging device 440b, where the second ground engaging device 440b may be similar or equivalent to the ground engaging device 440 of the first vehicle barrier 430a. In some embodiments, the second vehicle barrier 430b may comprise a first tip 440-1a and a second tip 440-1b, where the second tip 440-1b may be similar or equivalent to the ground tip 440-1 of the first vehicle barrier 430a. According to some embodiments, the second vehicle barrier 430b may comprise a first mass 446a and a second mass 446b, where the second mass 446b may be similar or equivalent to the mass 446 of the first vehicle barrier 430a.

According to some embodiments, such as in the case that the first activation unit 438a and/or the second activation unit 438b is triggered upon impact, the second vehicle barrier 430b may transition directly from the first state to the third state. According to some embodiments, upon impact a moment may be generated at the second vehicle barrier 430b as depicted by the rotational directional arrow in FIG. 4C and/or one or more of the ground engaging devices 440a-b may be driven into the ground/surface (e.g., further into the ground/surface) in accordance with the linear directional arrows as shown. In some embodiments, the activation units 438a-b may comprise multiple stages such that, for example, a first stage drives the ground engaging devices 440a-b into the ground by a first amount at the second time and/or a second stage drives the ground engaging devices 440a-b further into the ground by a second amount at the third time. According to some embodiments, the angle “A” may be configured to cause the impact force to act upon the second vehicle barrier 430b to further force the ground engaging devices 440a-b into the surface/ground. In other words, the force of the impact may be structurally routed to facilitate the anchoring of the second vehicle barrier 430b. In some embodiments, the first activation unit 438a and the second activation unit 438b may be triggered separately or individually in a coordinated manner. The first activation unit 438a may be triggered to fire the first ground engaging device 440a into the ground at a first time in response to a first trigger, for example, and the second activation unit 438b may be triggered to fire the second ground engaging device 440b into the ground at a second time. In some embodiments, the triggering of the second activation unit 438b may be initiated at the second time in response to the first trigger or may be initiated in response to a second trigger. According to some embodiments, one of the activation units 438a-b may be fired and/or triggered and the other activation unit 438a-b may selectively not be fired and/or triggered. In such a manner, for example, the activation units 438a-b may be electively triggered based upon different types of triggering events. In some embodiments, the different activation units 438a-b, ground engaging devices 440a-b, tips 440-1a, 440-1b, and/or masses 446a-b may comprise different sizes, materials, and/or configurations. In some embodiments, the different activation units 438a-b may be selectively and/or individually triggered based on the different sizes, materials, and/or configurations of the activation units 438a-b, ground engaging devices 440a-b, tips 440-1a, 440-1b, and/or masses 446a-b.

In some embodiments, fewer or more components 430-1, 430-2, 430-2a, 430-2b, 438, 438a-b, 440, 440a-b, 440-1, 440-1a, 440-1b, 446, 446a-b and/or various configurations of the depicted components 430-1, 430-2, 430-2a, 430-2b, 438, 438a-b, 440, 440a-b, 440-1, 440-1a, 440-1b, 446, 446a-b may be included in the vehicle barriers 430a-b without deviating from the scope of embodiments described herein. In some embodiments, the components 430-1, 430-2, 430-2a, 430-2b, 438, 438a-b, 440, 440a-b, 440-1, 440-1a, 440-1b, 446, 446a-b may be similar in configuration and/or functionality to similarly named and/or numbered components as described herein. In some embodiments, the vehicle barriers 430a-b (and/or portion thereof) may comprise an autonomous vehicle barrier deployment and/or activation system and/or platform programmed and/or otherwise configured to execute, conduct, and/or facilitate the method 900 of FIG. 9 herein, and/or portions thereof.

### III. Selectively-Deployable Vehicle Barrier Systems

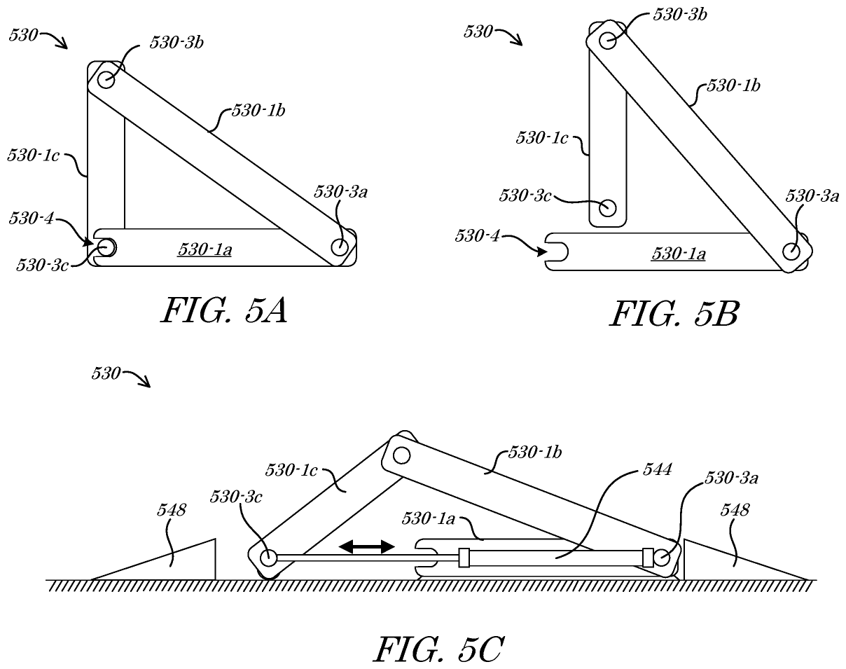

Referring now to FIG. 5A, FIG. 5B, and FIG. 5C, side views of a selectively-deployable vehicle barrier 530 according to some embodiments are shown. The vehicle barrier 530 may comprise, for example, a selectively deployed barrier that is configured to be raised and/or lowered as desired. In some embodiments, while not shown in FIG. 5A, FIG. 5B, or FIG. 5C for simplicity of illustration, the vehicle barrier 530 may comprise an “active” barrier that is operable and/or outfitted to autonomously and/or automatically anchor itself to the ground/surface, e.g., in response to detected threats. According to some embodiments, the vehicle barrier 530 may comprise a plurality of frame elements 530-1a, 530-1b, 530-1c such as a first or base frame element 530-1a, a second or structural frame element 530-1b, and/or a third or impact surface frame element 530-1c. In some embodiments, the frame elements 530-1a, 530-1b, 530-1c may be coupled via a plurality of respective hinge points, pivot points, and/or joints 530-3a, 530-3b, 530-3c.

As depicted for purposes of non-limiting example in FIG. 5A, one or more of the joints 530-3a, 530-3b, 530-3c, such as a third joint 530-3c may comprise a pin or coupling element that is sized and/or shaped to mate with and/or be accepted by a corresponding socket 530-4. According to some embodiments, the base frame element 530-1a may comprise the socket 530-4 at a leading end thereof and one end of the impact surface frame element 530-1c may comprise the third joint 530-3c (e.g., a pin or other protrusion) that is configured to fit within the socket 530-4. As depicted in FIG. 5A, in a first state and/or configuration the third joint 530-3c may be seated in and/or coupled to the socket 530-4 such that the vehicle barrier 530 forms a triangular cross-section or profile. This first state and/or configuration may comprise a “deployed” state and/or configuration, for example, such that the vehicle barrier 530 blocks the path of any oncoming vehicles (not shown). In some embodiments, and as depicted in FIG. 5B, the vehicle barrier 530 may be transitioned to (or from) a second state and/or configuration in which the third joint 530-3c may be disengaged from the socket 530-4 such that the triangular cross-section or profile is disassembled and the various frame elements 530-1a, 530-1b, 530-1c are free to be repositioned in accordance with the freedom of movement provided by a first joint 530-3a between the base frame element 530-1a and the structural frame element 530-1b and provided by a second joint 530-3b between the structural frame element 530-1b and the impact surface frame element 530-1c.

In some embodiments, and as depicted in FIG. 5C, an orientation device 544 such as a piston or other manipulation, translation, and/or rotation device may be coupled between and/or to the first joint 530-3a and/or the base frame element 530-1a and the third joint 530-3c such that the position of the third joint 530-3c may be controlled and/or set (e.g., along a plane parallel to the ground surface). According to some embodiments, the joints 530-3a, 530-3b, 530-3c may be manipulated and/or controlled such that the vehicle barrier 530 may be lowered or stowed (e.g., a “stowed” state), e.g., between a pair of ramps 548. As depicted in FIG. 5C, for example, the piston of the orientation device 544 may be elongated to move the third joint 530-3c away from the socket 530-4 such that the structural frame element 530-1b and the impact surface frame element 530-1c lie flat, e.g., along the ground surface with the base frame element 530-1a. In such a manner, the vehicle barrier 530 may be selectively lowered or stowed such that vehicles (e.g., authorized vehicles) may drive over the ramps 548 and frame elements 530-1a, 530-1b, 530-1c to pass over the vehicle barrier 530 (and gain access to a secured area). In some embodiments, the piston of the orientation device 544 may be retracted to move the third joint 530-3c toward the socket 530-4 such that the structural frame element 530-1b attains an angled orientation and the impact surface frame element 530-1c is disposed substantially perpendicular to (e.g., vertical) a desired and/or estimated direction of potential impact (e.g., the “deployed” position as depicted in FIG. 5A). According to some embodiments, the vehicle barrier 530 may be deployed (e.g., raised) in response to a detection of a potential threat, as described herein. Similarly, when in the deployed position, anchoring mechanisms (not shown) within and/or coupled to the structural frame element 530-1b may be actuated to anchor the vehicle barrier 530 to the ground/surface (e.g., between the ramps 548.

In some embodiments, fewer or more components 530-1a, 530-1b, 530-1c, 530-3a, 530-3b, 530-3c, 530-4, 544, 548 and/or various configurations of the depicted components 530-1a, 530-1b, 530-1c, 530-3a, 530-3b, 530-3c, 530-4, 544, 548 may be included in the vehicle barrier 530 without deviating from the scope of embodiments described herein. In some embodiments, the components 530-1a, 530-1b, 530-1c, 530-3a, 530-3b, 530-3c, 530-4, 544, 548 may be similar in configuration and/or functionality to similarly named and/or numbered components as described herein. In some embodiments, the vehicle barrier 530 (and/or portion thereof) may comprise an autonomous vehicle barrier deployment and/or activation system and/or platform programmed and/or otherwise configured to execute, conduct, and/or facilitate the method 900 of FIG. 9 herein, and/or portions thereof.

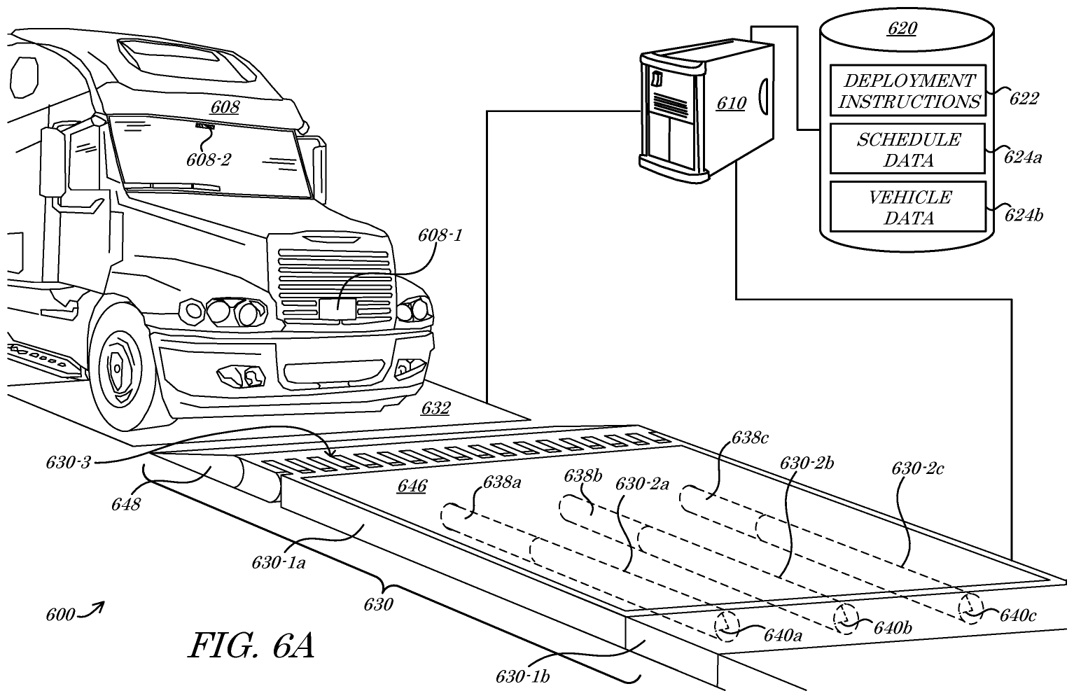

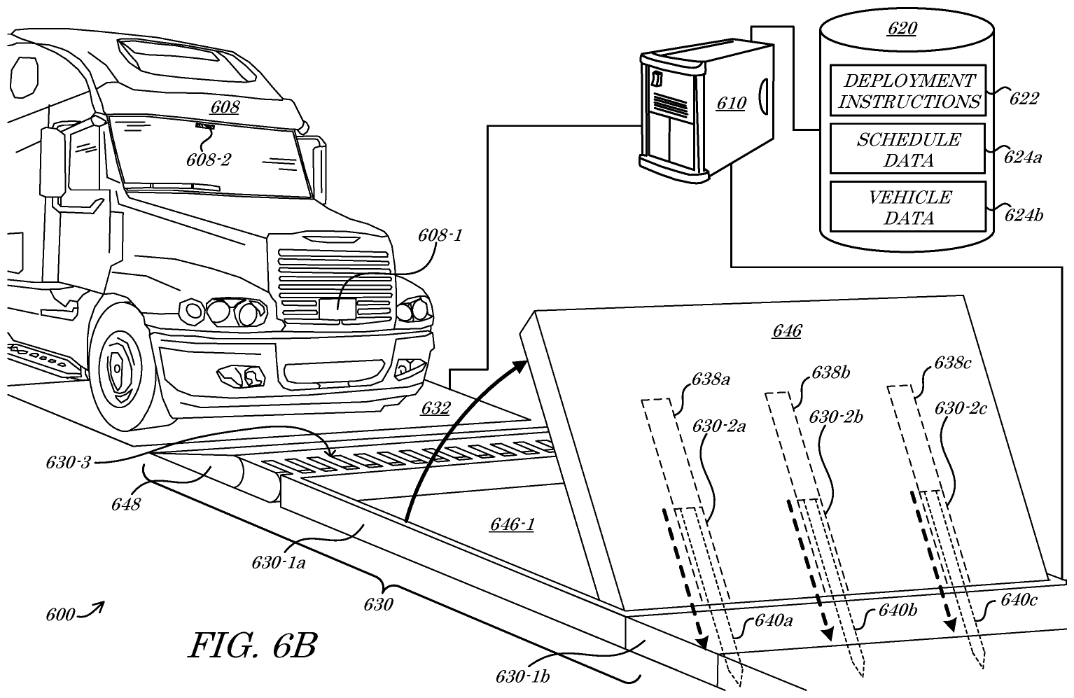

Turning now to FIG. 6A and FIG. 6B, perspective views of a system 600 according to some embodiments are shown. In some embodiments, the system 600 may be similar in configuration and/or functionality to the systems 100, 200, 300 of FIG. 1, FIG. 2, and/or FIG. 3 herein. The system 600 may comprise, for example, a vehicle 608 comprising one or more identifiers 608-1, 608-2. According to some embodiments, the vehicle 608 may be detected, identified, classified, located, and/or tracked by a controller device 610 in communication with a memory 620 storing deployment instructions 622, schedule data 624a, and/or vehicle data 624b. The controller 610 may execute the deployment instructions 622 based on data descriptive of the vehicle 608 (e.g., the one or more identifiers 608-1, 608-2), for example, to selectively and/or autonomously control a modular vehicle barrier 630. In some embodiments, the modular vehicle barrier 630 may comprise a foldable and/or detachable set of fame elements 630-1a, 630-1b, 630-1c such as a primary frame element 630-1a and/or a secondary frame element 630-1b. In some embodiments, although depicted separately for ease of illustration, some or all of the electronic components such as the controller device 610 and the memory 620 may be stored in and/or coupled to the modular vehicle barrier 630. The secondary frame element 630-1b may comprise, for example, an electronics element that houses various electronic components such as the controller device 610 and/or the memory 620 (and/or other wires, cables, connectors, power supplies, etc.; not shown).

According to some embodiments, the modular vehicle barrier 630 may comprise a plurality of bores 630-2a, 630-2b, 630-2c disposed and/or formed therein and/or coupled thereto. In some embodiments, the modular vehicle barrier 630 may comprise one or more hinges 630-3 that permit the frame elements 630-1a, 630-1b and/or other connected structures to be folded, nested, and/or otherwise selectively placed, deployed, and/or activated. Data descriptive of the vehicle 608 such as the one or more identifiers 608-1, 608-2 and/or data received from a sensor 632 may be processed by the controller device 610 in accordance with the deployment instructions 622 and/or with respect to (e.g., utilizing as input) one or more of the schedule data 624a and/or the vehicle data 624b, for example, to selectively activate one or more firing units 638a-c disposed in and/or coupled to the bores 630-2a, 630-2b, 630-2c. The firing units 638a-c may, for example, be operable (e.g., upon activation and/or triggering) to fire respective ground engaging devices 640a-c from the bores 630-2a, 630-2b, 630-2c.

In some embodiments, the bores 630-2a, 630-2b, 630-2c housing the ground engaging devices 640a-c and/or the respective firing units 638a-c may be disposed in or on a barrier 646. The barrier 646 may, for example, comprise a steel, concrete, and/or composite slab of material in which the bores 630-2a, 630-2b, 630-2c housing the ground engaging devices 640a-c and the respective firing units 638a-c may be disposed and/or coupled. According to some embodiments, the barrier 646 may be selectively oriented at different positions and/or angles such as to selectively either permit the vehicle 608 to pass over the modular vehicle barrier 630 or to be stopped by the modular vehicle barrier 630. As depicted in FIG. 6A, for example the barrier 646 may be disposed in a first or stowed position in which it lies flat within a barrier recess 646-1 (separately discernable and labeled in FIG. 6B) defined by the primary frame element 630-1a. The first position may comprise a position in which the modular vehicle barrier 630 resides and/or is disposed prior to arrival and/or detection of the vehicle 608, for example, and/or in which the modular vehicle barrier 630 is selectively disposed to permit the vehicle 608 to pass. According to some embodiments, the modular vehicle barrier 630 may comprise and/or be coupled to one or more ramps 648 (e.g., via the joint 630-3) that facilitate passage of the vehicle 608 over the modular vehicle barrier 630, e.g., in the case that the barrier 646 is disposed in the first or stowed position as depicted in FIG. 6A.

According to some embodiments, the controller device 610 may selectively raise and/or lower the barrier 646 (e.g., utilizing an orientation device, not shown; such as a motor, gears, linkage, pulleys, springs, cords, cables, winches, counter weights, etc.) based on computations derived from execution of the deployment instructions 622. The resting or default position of the modular vehicle barrier 630 may comprise the first or stowed position of FIG. 6A, for example, and the controller device 610 may deploy the barrier 646 by raising it at an angle with respect to the ground surface (and/or with respect to the primary frame element 630-1a) in response to data descriptive of the vehicle 608. As a first tier of safety and/or threat mitigation, for example, upon detection of the vehicle 608 by the sensor 632, the barrier 646 may be transitioned to a deployed angle, as depicted in FIG. 6B. According to some embodiments, the default and/or resting position of the modular vehicle barrier 630 may comprise the second position at an angle such as depicted in FIG. 6B and the controller device 610 may selectively lower or stow the barrier 646 in response to the data descriptive of the vehicle 608. In the case that an authorized identifier 608-1, 608-2 is detected and/or identified, for example, the deployed barrier 646 may be lowered to the first position depicted in FIG. 6A to permit the authorized vehicle 608 to pass.

In some embodiments, deployment (e.g., raising, lowering, and/or otherwise moving or repositioning) of the barrier 646 may comprise a first stage or tier of threat response. According to some embodiments, a second tier or stage of threat response may comprise deployment, activation, and/or triggering of the ground engaging devices 640a-c. As depicted in FIG. 6B, for example, in the case that the barrier 646 is in a deployed orientation such that openings of the bores 630-2a, 630-2b, 630-2c are orientated at a desired angle toward the ground/roadway surface, one or more of the firing units 638a-c may be activated to fire the corresponding ground engaging devices 640a-c into the ground, thereby anchoring the barrier 646. In some embodiments, firing units 638a-c may be selectively engaged based on the data descriptive of the vehicle 608, based on the particular type of ground engaging devices 640a-c disposed in the different bores 630-2a, 630-2b, 630-2c, and/or based on other information (such as surface type data). The second tier or stage of threat mitigation may comprise activation of only a second firing unit 638b, for example, such as in the case that the vehicle 608 comprises a size and/or mass computed to be below a certain threshold. In the case that the vehicle 608 is computed to be larger than the threshold and/or in the case that the speed of the vehicle exceeds a speed threshold, the second stage may comprise activating each of a first firing unit 638a and a third firing unit 638c—e.g., providing more anchoring and accordingly more stopping force to counter act the vehicle 608. In some embodiments, a third tier or stage of threat mitigation may comprise activation of any or all remaining (e.g., unfired) firing units 638a-c. While three (3) firing units 638a-c and respective bores 630-2a, 630-2b, 630-2c and ground engaging devices 640a-c are depicted in FIG. 6A and FIG. 6B, fewer or more such devices 638a-c, 630-2a, 630-2b, 630-2c, 640a-c may be included in the system 600 in accordance with some embodiments. Similarly, while a single modular vehicle barrier 630 and/or barrier 646 are depicted, additional modular vehicle barriers 630 and/or barriers 646 may be included in the system 600 as desired (e.g., in series—based on the expected stopping forces needed and/or in parallel—based on a width of a passage and/or roadway that requires governing/protection.

In some embodiments, fewer or more components 608, 608-1, 608-2, 610, 622, 624a-b, 630, 630-1a, 630-1b, 630-1a, 630-2b, 630-2c, 630-3, 632, 638a-c, 640a-c, 646, 646-1, 648 and/or various configurations of the depicted components 608, 608-1, 608-2, 610, 622, 624a-b, 630, 630-1a, 630-1b, 630-1a, 630-2b, 630-2c, 630-3, 632, 638a-c, 640a-c, 646, 646-1, 648 may be included in the system 600 without deviating from the scope of embodiments described herein. In some embodiments, the components 608, 608-1, 608-2, 610, 622, 624a-b, 630, 630-1a, 630-1b, 630-1a, 630-2b, 630-2c, 630-3, 632, 638a-c, 640a-c, 646, 646-1, 648 may be similar in configuration and/or functionality to similarly named and/or numbered components as described herein. In some embodiments, the system 600 (and/or portion thereof) may comprise an autonomous vehicle barrier deployment and/or activation system and/or platform programmed and/or otherwise configured to execute, conduct, and/or facilitate the method 900 of FIG. 9 herein, and/or portions thereof.

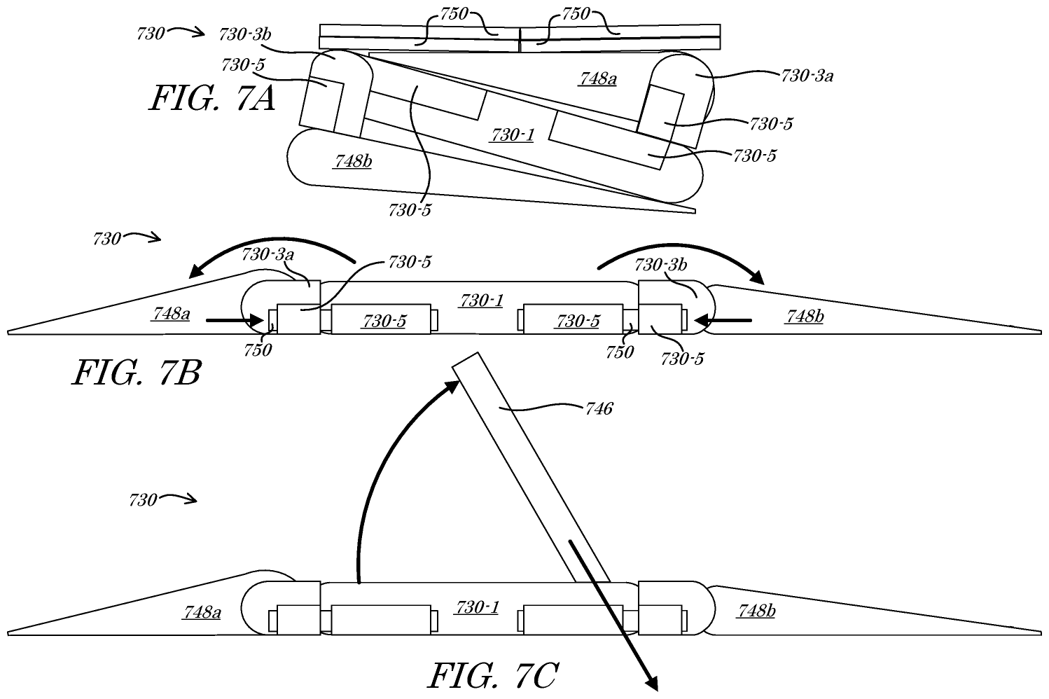

Turning now to FIG. 7A, FIG. 7B, and FIG. 7C, side views of a vehicle barrier 730 according to some embodiments are shown. The vehicle barrier 730 may, in some embodiments, comprise a modular barrier that is configured and/or constructed as multiple conjoined elements that may be folded to a compact orientation for shipping and/or storage and may be unfolded and/or deployed to provide selective and/or autonomous protection to vehicle passages (not shown; e.g., the vehicle passage 106 of FIG. 1 herein). The vehicle barrier 730 may comprise, for example, a frame 730-1 coupled at each end thereof to a joint 730-3a, 730-3b. In some embodiments, each of the frame 730-1 and the joints 730-3a, 730-3b may comprise and/or define sleeves 730-5, e.g., coupled along the sides thereof. According to some embodiments, the frame 730-1 may house and/or be coupled to a barrier element 746 (discernable and separately labeled in a deployed position in FIG. 7C). In some embodiments, each joint 730-3a, 730-3b may be coupled to a ramp 748a-b.

According to some embodiments, and as depicted in FIG. 7A, the vehicle barrier 730 may be disposed in a first and/or stored configuration in which a first ramp 748a is disposed on top of the frame 730-1 (to which it is coupled via a first joint 730-3a) and a second ramp 749b is disposed underneath the frame 730-1 (to which it is coupled via a second joint 730-3b). In some embodiments bars 750 may be bundled, stored, and/or placed on top of the first ramp 748a, such that the entire vehicle barrier 730 may be readily transported (e.g., via a forklift; not shown) and/or may be efficiently and/or safely stored.

In some embodiments, and as depicted in FIG. 7B, the vehicle barrier 730 may be disposed in a second and/or deployed configuration in which the first ramp 748a is disposed along a plane (e.g., a ground or surface plane) on a first side of the frame 730-1, the frame 730-1 is disposed along the plane, and the second ramp 748b is also disposed along the plane on a second side of the frame 730-1. In such a manner, for example, the vehicle barrier 730 may be unfolded to form a raised portion of a roadway and/or passage over which vehicles (not shown) may travel. According to some embodiments, the vehicle barrier 730 may be secured in the second configuration by engagement of the bars 750 with the various sleeves 730-5. In some embodiments, the ramps 74a-b may also or alternatively comprise and/or define sleeves 730-5 through which the bars 750 may pass and/or be engaged, e.g., to prevent folding of the vehicle barrier 730.

According to some embodiments, and as depicted in FIG. 7C, the vehicle barrier 730 may be disposed in the third and/or activated configuration in which the barrier element 746 is raised from the frame 730-1. After being unfolded and/or deployed, for example, the third configuration may be selectively achieved by activation of a motor or other orientation device (not shown) coupled to raise and/or lower the barrier element 746, e.g., to a desired height, angle, etc. According to some embodiments, the barrier element 746 and/or the vehicle barrier 730 may also be selectively anchored to the ground/surface by deployment of anchoring devices (not shown) from the barrier element 746. In such a manner, for example, the vehicle barrier 730 may be capable of stopping vehicles with a smaller barrier element 746 than would normally be required by taking advantage of selectively anchoring deployment. The reduced size of the barrier element 746 may permit the vehicle barrier 730 to be safely and effectively transported (e.g., in the first or stowed configuration) by standard machinery (such as a forklift), whereas a typical barrier element 746 that would have an equivalent un-anchored stopping force would require significantly larger machinery—e.g., a crane. In some embodiments, stowage of the vehicle barrier 730 may require lowering and/or stowage of the barrier element 746 in the frame 730-1, removal of the bars 750 from the sleeves 730-5, and folding of the ramps 748a-b.

In some embodiments, fewer or more components 730-1, 730-3a, 730-3b, 730-5, 746, 748a-b, 750 and/or various configurations of the depicted components 730-1, 730-3a, 730-3b, 730-5, 746, 748a-b, 750 may be included in the vehicle barrier 730 without deviating from the scope of embodiments described herein. In some embodiments, the components 730-1, 730-3a, 730-3b, 730-5, 746, 748a-b, 750 may be similar in configuration and/or functionality to similarly named and/or numbered components as described herein. In some embodiments, the vehicle barrier 730 (and/or portion thereof) may comprise an autonomous vehicle barrier deployment and/or activation system and/or platform programmed and/or otherwise configured to execute, conduct, and/or facilitate the method 900 of FIG. 9 herein, and/or portions thereof.

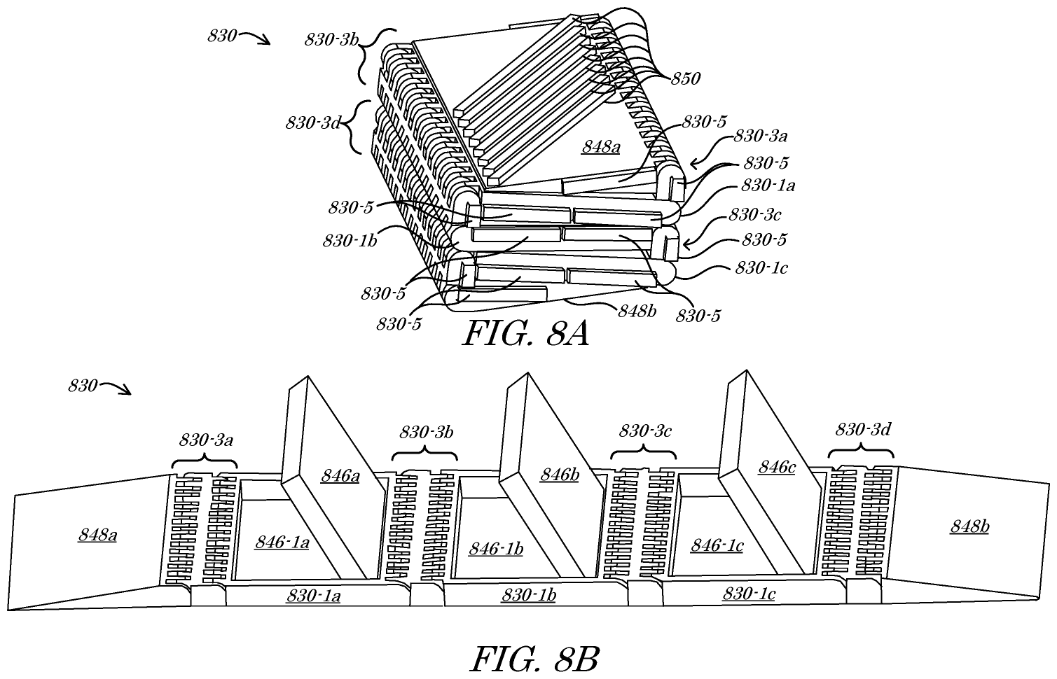

Referring now to FIG. 8A and FIG. 8B, perspective views of a vehicle barrier 830 according to some embodiments are shown. The vehicle barrier 830 may, in some embodiments, comprise a modular, multi-segment barrier that is configured and/or constructed as multiple conjoined elements that may be folded to a compact orientation for shipping and/or storage and may be unfolded and/or deployed to provide selective and/or autonomous protection to vehicle passages (not shown; e.g., the vehicle passage 106 of FIG. 1 herein). The vehicle barrier 830 may comprise, for example, a plurality of frames 830-1a, 830-1b, 830-1c coupled to a plurality of joints 830-3a, 830-3b, 830-3c, 830-3d and/or comprising or defining a plurality of sleeves 830-5. In some embodiments, the vehicle barrier 830 may comprise a plurality of barrier elements 846a-c, each barrier element 846a-c being disposed and/or seated in a respective barrier recess 846-1a, 846-1b, 846-1c of the frames 830-1a, 830-1b, 830-1c. According to some embodiments, the vehicle barrier 830 may comprise an entry ramp 848a and/or an exit ramp 848b.

According to some embodiments, and as depicted in FIG. 8A, the vehicle barrier 830 may be folded for storage and/or transport. The entry ramp 848a may be disposed on top of a first frame 830-1a (which are coupled together via a first joint 830-3a), the first frame 830-1a may be disposed on top of a second frame 830-1b (which are coupled together via a second joint 830-3b), the second frame 830-1b may be disposed on top of a third frame 830-1c (which are coupled together via a third joint 830-3c), and/or the third frame 830-1c may be disposed on top of the exit ramp 848b (which are coupled together via a fourth joint 830-3d). In some embodiments, bars 850 may be stored with (e.g., on top of) the vehicle barrier 830 and/or package therewith.

In some embodiments, and as depicted in FIG. 8B, the vehicle barrier 830 may be unfolded and/or deployed for vehicular access control. The entry ramp 848a may be unfolded and disposed along a surface at a first end of the first frame 830-1a (with the first joint 830-3a therebetween), the first frame 830-1a may be unfolded and disposed along the surface at a first end of the second frame 830-1b (with the second joint 830-3b therebetween), the second frame 830-1b may be unfolded and disposed along the surface at a first end of the third frame 830-1c (with the third joint 830-3c therebetween), and/or the third frame 830-1c may be unfolded and disposed along the surface at a first end of the exit ramp 848b (with the fourth joint 830-3d therebetween). In some embodiments, the bars 850 may be engaged with the sleeves 830-5 (shown only in FIG. 8A for ease of illustration) to lock the various components 830-1a, 830-1b, 830-1c, 830-3a, 830-3b, 830-3c, 830-3d, 848a-b together in the deployed configuration. According to some embodiments, the barrier elements 846a-c may be selectively stored in their respective barrier recesses 846-1a, 846-1b, 846-1c or deployed at various angles with respect to the surface, e.g., in deployed states as depicted in FIG. 8B. In some embodiments, deployment of the barrier elements 846a-c may arm integrated firing units (not shown) and/or stowage of the barrier elements 846a-c may activate a safety (not shown) and/or disarm the firing units. In some embodiments, the various barrier elements 846a-c may be individually and/or jointly deployed, oriented, and/or activated or anchored, e.g., in response to detection and/or computation of threats as described herein. While all three (3) barrier elements 846a-c are depicted as being deployed in FIG. 8B, for example, such a configuration may comprise a particular tier or stage of response to a threat (e.g., an evaluated threat or an automatic response threat). All three (3) barrier elements 846a-c may be required (or desired) to stop a large and/or high-speed vehicle (not shown), for example, while one (1) or two (2) barrier elements 846a-c may be alternatively deployed and/or activated in response to different levels of threat (e.g., smaller and/or slower vehicles).

According to some embodiments, the different barrier elements 846a-c and/or frames 830-1a, 830-1b, 830-1c may be selectively coupled to the modular, multi-segment vehicle barrier 830 based on desired configurations for different expected threats. Each barrier elements 846a-c may comprise a different magnitude of mass and/or different material, for example, each of which may be suited for responding to different threats. In some embodiments, a first barrier element 846a may be configured for lighter responses and may comprise a first magnitude of mass and/or be constructed of a first material, for example, while a second barrier element 846b may be configured for a medium response and may comprise a second magnitude of mass that is larger than the first magnitude and/or be constructed of a second material that is different than the first material. In such a manner, for example, the first barrier element 846a may be selectively deployed for certain threats having computed values falling within a threshold while the second barrier element 846b may be selectively deployed for different threats having computed values falling above the computed threshold. Similarly, a third barrier element 846c may comprise a third magnitude of mass larger than the second magnitude and/or may be constructed of a material (or materials) that have higher strength than a strength of the first and/or second materials, and may accordingly be deployed for the most severe computed threats. In some embodiments, any or all of the barrier elements 846a-c and/or respective frames 830-1a, 830-1b, 830-1c may be actively anchored to the surface by engagement of ground-penetration devices (not shown) as described herein. In some embodiments, each frame 830-1a, 830-1b, 830-1c and/or respective barrier element 846a-c may comprise different types, quantities, and/or magnitudes of ground-penetration devices. According to some embodiments, the different ground-penetrating devices may be selected for activation based on the computed threat levels and/or details.

In some embodiments, the deployment of the barrier elements 846a-c may be coordinated for staged vehicular control purposes. The first two barrier elements 846a-b may be retracted or stowed (not shown), for example, permitting a vehicle to approach the third barrier element 846c (e.g., deployed as a barrier as depicted in FIG. 8B). According to some embodiments, the first barrier element 846a may then be deployed, retaining the vehicle on the second frame 830-1b between the first and third deployed barrier elements 846a, 846c. In such a manner, for example, the multi-segment vehicle barrier 830 may be employed to control vehicular advancement. While three (3) frames 830-1a, 830-1b, 830-1c and respective barrier elements 846a-c are depicted in FIG. 8A and FIG. 8B, in some embodiments fewer or more frames 830-1a, 830-1b, 830-1c and/or barrier elements 846a-c may be utilized.

In some embodiments, fewer or more components 830-1a, 830-1b, 830-1c, 830-3a, 830-3b, 830-3c, 830-3d, 830-5, 846a-c, 848a-b, 850 and/or various configurations of the depicted components 830-1a, 830-1b, 830-1c, 830-3a, 830-3b, 830-3c, 830-3d, 830-5, 846a-c, 848a-b, 850 may be included in the vehicle barrier 830 without deviating from the scope of embodiments described herein. In some embodiments, the components 830-1a, 830-1b, 830-1c, 830-3a, 830-3b, 830-3c, 830-3d, 830-5, 846a-c, 848a-b, 850 may be similar in configuration and/or functionality to similarly named and/or numbered components as described herein. In some embodiments, the vehicle barrier 830 (and/or portion thereof) may comprise an autonomous vehicle barrier deployment and/or activation system and/or platform programmed and/or otherwise configured to execute, conduct, and/or facilitate the method 900 of FIG. 9 herein, and/or portions thereof.

### IV. Vehicle Barrier Methods

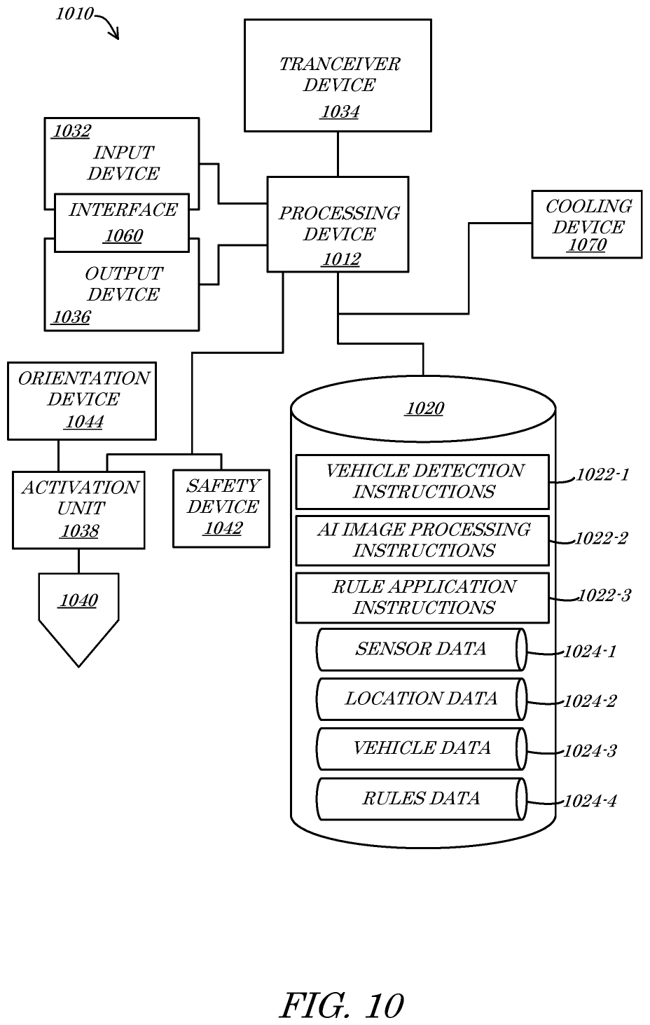

Turning to FIG. 9, a flow diagram of a method 900 according to some embodiments is shown. In some embodiments, the method 900 may be performed and/or implemented by and/or otherwise associated with one or more specialized and/or specially-programmed computers (e.g., the controller devices 110, 210, 310a-b, 610 of FIG. 1, FIG. 2, FIG. 3, FIG. 6A, and/or FIG. 6B herein), computer terminals, computer servers, computer systems and/or networks, and/or any combinations thereof. In some embodiments, the method 900 may be embodied in, facilitated by, and/or otherwise associated with various input mechanisms and/or interfaces and/or may be effectuated by the execution of one or more stored programs, modules, routines, rule sets, and/or logical steps, e.g., as defined by one or more rule-based, logic, and/or AI programs and/or modules (e.g., the logic 122, 222, triggering instructions 322, deployment instructions 622, and/or the various instructions 1022-1, 1022-2, 1022-3 of FIG. 1, FIG. 2, FIG. 3, FIG. 6A, FIG. 6B, and/or FIG. 10 herein).

The process diagrams and flow diagrams described herein do not necessarily imply a fixed order to any depicted actions, steps, and/or procedures, and embodiments may generally be performed in any order that is practicable unless otherwise and specifically noted. While the order of actions, steps, and/or procedures described herein is generally not fixed, in some embodiments, actions, steps, and/or procedures may be specifically performed in the order listed, depicted, and/or described and/or may be performed in response to any previously listed, depicted, and/or described action, step, and/or procedure. Any of the processes and methods described herein may be performed and/or facilitated by hardware, software (including microcode), firmware, or any combination thereof. For example, a storage medium (e.g., a hard disk, Random Access Memory (RAM) device, cache memory device, Universal Serial Bus (USB) mass storage device, and/or Digital Video Disk (DVD); e.g., the memory devices 120, 220, 320, 620, 1020 of FIG. 1, FIG. 2, FIG. 3, FIG. 6A, FIG. 6B, and/or FIG. 10 herein) may store thereon instructions that when executed by a machine (such as a computerized processor) result in performance according to any one or more of the embodiments described herein.

In some embodiments, the method 900 may comprise detecting (e.g., by an electronic processing device and/or by executing an AI logic routine) an object, at 902. One or more sensors may acquire information or data, for example, that is analyzed and/or processed to identify a presence of an object, e.g., in proximity to (and/or on a trajectory headed for) a vehicle passage. In some embodiments, the presence of data from a sensor such as a motion sensor may be indicative of an object. According to some embodiments, images and/or other data may be processed through one or more analysis routines to identify patterns, shapes, and/or other features that match stored data indicative of the object.

According to some embodiments, the method 900 may comprise identifying (e.g., by the electronic processing device and/or by executing the AI logic routine) the object, at 904. Received and/or acquired data may be compared to stored data, for example, to cross-reference and/or match data descriptive of the object to stored data related to an identification of the object. In the case of object recognition, for example, certain characteristics of the object may be matched to stored data elements indicative of a particular make, model, and/or type of object. According to some embodiments, the data may comprise an identifier (e.g., a license plate number, VIN, barcode, and/or transponder identifier) which may be cross-referenced to stored data to identify a particular object and/or characteristics thereof. In accordance with many embodiments herein, the object may be identified and/or classified as a vehicle, a vehicle of a particular type, make, and/or model, and/or a vehicle of a particular size, shape, and/or mass (e.g., estimated and/or measured). In some embodiments, characteristics of the object/vehicle may be identified, computed, and/or calculated, such as speed, acceleration, location, trajectory, heading, route, temperature, color, etc.

In some embodiments, the method 900 may comprise identifying (e.g., by the electronic processing device and/or by executing the AI logic routine) a rule for the object, at 906. Data stored in relation to the type, classification, and/or identity of the object may be queried, for example, to identify one or more rules corresponding to the object and/or corresponding to a particular location and/or a particular active (and/or modular) vehicle barrier. Different rules may be programmed for different barriers, locations (e.g., barrier setup locations), coordinates, and/or object characteristics, for example. Such rules may be simple or binary, in some embodiments, such as requiring any approaching vehicle to be below a certain threshold speed or not permitting any vehicle over a certain Gross Vehicle Weight (GVW) or actual weight/mass. According to some embodiments, the rules may be tiered, hierarchical, and/or arranged in a decision tree framework. Certain types of vehicles may be permitted at certain times of the day, for example, or vehicles traveling within a predefined speed range may be permitted if detected during a certain time window and/or if observed to be following a certain path or route.

According to some embodiments, the method 900 may comprise determining (e.g., by the electronic processing device and/or by executing the AI logic routine) whether the rule(s) is met (or satisfied), at 908. One or more thresholds and/or logical rules and/or criteria may be evaluated, for example, to determine whether the acquired, measured, received, and/or computed data descriptive of one or more characteristics of the object falls within acceptable ranges. In the case that the data is found to fall within acceptable ranges for any or all applicable rules, the method 900 may proceed to identifying (e.g., by the electronic processing device and/or by executing the AI logic routine) a barrier state, at 910. Active, modular, and/or multi-segment vehicle barriers such as autonomously managed vehicle barriers as described herein, for example, may be oriented and/or disposed in various states such as deployed, anchored, stowed (or undeployed), etc. In the case that all applicable rules have been met or satisfied, the identified object may be considered to not be a threat and in the case of an approaching vehicle, may be permitted to pass. Accordingly, the current state and/or orientation of the barrier may be determined to effectuate the desired result with respect to the object.

In some embodiments, the method 900 may comprise determining (e.g., by the electronic processing device and/or by querying stored data) whether the barrier is deployed, at 912. The status of the barrier (and/or barriers) may be analyzed for example, to determine whether the barrier is currently deployed and/or otherwise blocking a path of the vehicle. In the case that the barrier is already stowed or not deployed, the method 900 may simply revert to detecting and/or monitoring for additional objects at 902. In the case that the barrier is determined to be deployed, the method 900 may proceed to stowing (e.g., by the electronic processing device and/or by transmission of a command signal) the barrier, at 914. An orientation device such as a motor, hydraulic actuator, and/or pneumatic control valve may be commanded, for example, to lower and/or move the deployed barrier to permit the authorized vehicle to pass.

According to some embodiments, in the case that one or more rules are determined not to be met, at 908, the method 900 may proceed to and/or comprise determining (e.g., by the electronic processing device and/or by querying stored data) whether the barrier is deployed, at 916. The status of the barrier (and/or barriers) may be analyzed for example, to determine whether the barrier is currently undeployed, stowed, and/or otherwise not blocking a path of the vehicle. In the case that the barrier is not blocking the path of the vehicle, the method 900 may proceed to deploying (e.g., by the electronic processing device and/or by transmission of a command signal) the barrier, at 918. An orientation device such as a motor, hydraulic actuator, and/or pneumatic control valve may be commanded, for example, to raise and/or move the undeployed barrier to block the path of the unauthorized vehicle. In some embodiments, and as indicated by the dotted line to 918 in FIG. 9, the barrier may also or alternatively be deployed in response to detection of the object, at 902. According to some embodiments, once deployed, e.g., to block the path of the unauthorized vehicle, or in the case that the barrier is determined to already be deployed at 916, the method 900 may proceed by computing (e.g., by the electronic processing device and/or by executing the AI logic routine) a threat level, at 920. In some embodiments for example, data descriptive of an object/vehicle may warrant blocking the path of the vehicle but may not require anchoring the vehicle barrier to the ground. As anchoring may significantly damage the underlying surface, for example, it may be selectively triggered only for threats of a certain magnitude. In some embodiments, the data descriptive of the object/vehicle may be analyzed (e.g., with respect to the applicable rules) to determine if the object/vehicle violates a sufficient number of rules and/or violates certain specific rules, which warrant additional action. In some embodiments, the object/vehicle may be assigned a certain number of points with respect to evaluation for each applicable rule and may accordingly achieve a score or rank with respect to how deviant and/or compliant the object/vehicle is with respect to all applicable criteria.

In some embodiments, the method 900 may comprise determining (e.g., by the electronic processing device and/or by executing the AI logic routine) whether to anchor the barrier, at 922. In the case that certain rules, certain maximum threshold number of rules, and/or certain point thresholds are exceeded or violated, for example, it may be determined that anchoring of the barrier is required (e.g., to stop the vehicle). In such cases, the method 900 may proceed to triggering (e.g., by the electronic processing device and/or by transmission of a command signal) the anchors, at 924. As described herein, for example, in response to a detected threat (e.g., exceeding a predefined threshold) an active and/or modular vehicle barrier may propel one or more anchoring devices into the ground to multiply the effective stopping force of a deployed barrier element. As indicated by the dotted line from the deploying at 918 to the triggering of the anchors at 924, in some embodiments the anchors may automatically be deployed without analyzing or processing rules. In the case of high-security installations, for example, any deployed barrier that detects an approaching vehicle may automatically anchor itself to the ground in anticipation of impact. In some embodiments, any deployed barrier that detects an impact may similarly automatically trigger anchoring. As further described herein, different barriers in communication with each other (e.g., arranged in series and/or in parallel) may cause action for other barriers. In the case that a first barrier detects an impact, for example, one or more other barriers may automatically deploy and/or anchor themselves in preparation for breach of the first barrier. In some embodiments, in the case that the threat level is not computed to warrant anchoring of the barrier, the method 900 may proceed and/or revert to detecting and/or monitoring for additional objects at 902.

### V. Vehicle Barrier Apparatus and Articles of Manufacture

Turning to FIG. 10, a block diagram of an apparatus 1010 according to some embodiments is shown. In some embodiments, the apparatus 1010 may be similar in configuration and/or functionality to any of the controller devices 110, 210, 310a-b, 610, the user device 102, and/or the sensor devices 232, 332a-b, 632 of FIG. 1, FIG. 2, FIG. 3, FIG. 6A, and/or FIG. 6B herein. The apparatus 1010 may, for example, execute, process, facilitate, and/or otherwise be associated with the method 900 of FIG. 9 herein, and/or portions thereof. In some embodiments, the apparatus 1010 may comprise a processing device 1012, a memory device 1020 (storing various programs and/or instructions 1022 and data 1024), an input device 1032, a transceiver device 1034, an output device 1036, an activation unit 1038, a ground engaging device 1040, a safety device 1042, an orientation device 1044, an interface 1060, and/or a cooling device 1070. According to some embodiments, any or all of the components 1012, 1020, 1022, 1024, 1032, 1034, 1036, 1038, 1040, 1042, 1044, 1060, 1070 of the apparatus 1010 may be similar in configuration and/or functionality to any similarly named and/or numbered components described herein. Fewer or more components 1012, 1020, 1022, 1024, 1032, 1034, 1036, 1038, 1040, 1042, 1044, 1060, 1070 and/or various configurations of the components 1012, 1020, 1022, 1024, 1032, 1034, 1036, 1038, 1040, 1042, 1044, 1060, 1070 be included in the apparatus 1010 without deviating from the scope of embodiments described herein.

According to some embodiments, the processor 1012 may be or include any type, quantity, and/or configuration of processor that is or becomes known. The processor 1012 may comprise, for example, an Intel® IXP 2800 network processor or an Intel® XEON™ Processor coupled with an Intel® E6501 chipset. In some embodiments, the processor 1012 may comprise multiple inter-connected processors, microprocessors, and/or micro-engines. According to some embodiments, the processor 1012 (and/or the apparatus 1010 and/or other components thereof) may be supplied power via a power supply (not shown), such as a battery, an Alternating Current (AC) source, a Direct Current (DC) source, an AC/DC adapter, solar cells, and/or an inertial generator. In the case that the apparatus 1010 comprises a server, such as a blade server, necessary power may be supplied via a standard AC outlet, power strip, surge protector, and/or Uninterruptible Power Supply (UPS) device.

In some embodiments, the transceiver device 1034 may comprise any type or configuration of communication device that is or becomes known or practicable. The transceiver device 1034 may, for example, comprise a Network Interface Card (NIC), a telephonic device, a cellular network device, a router, a hub, a modem, and/or a communications port or cable. According to some embodiments, the transceiver device 1034 may also or alternatively be coupled to the processor 1012. In some embodiments, the transceiver device 1034 may comprise an IR, RF, Bluetooth™, Near-Field Communication (NFC), and/or Wi-Fi® network device coupled to facilitate communications between the processor 1012 and another device (not shown).

According to some embodiments, the input device 1032 and/or the output device 1036 may be communicatively coupled to the processor 1012 (e.g., via wired and/or wireless connections and/or pathways) and they may generally comprise any types or configurations of input and output components and/or devices that are or become known, respectively. The input device 1032 may comprise, for example, a keyboard that allows an operator of the apparatus 1010 to interface with the apparatus 1010, the safety device 1044, and/or may comprise a sensor device and/or array. The output device 1036 may, according to some embodiments, comprise a display screen, a warning device such as a light and/or sounder, the orientation device 1044, the activation unit 1038, and/or other practicable output component and/or device, and/or combination thereof. The output device 1036 may, in some embodiments, provide an interface via which AI-based autonomous vehicle barrier information is provided to a user (e.g., via a website, display device, speaker, and/or mobile application). According to some embodiments, the input device 1032 and/or the output device 1036 may comprise and/or be embodied in a single device, such as a touch-screen monitor or display.

The memory device 1020 may comprise any appropriate information storage device that is or becomes known or available, including, but not limited to, units and/or combinations of magnetic storage devices (e.g., a hard disk drive), optical storage devices, and/or semiconductor memory devices, such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 1020 may, according to some embodiments, store one or more of vehicle detection instructions 1022-1, AI image processing instructions 1022-2, rule application instructions 1022-3, sensor data 1024-1, location data 1024-2, vehicle data 1024-3, and/or rules data 1024-4. In some embodiments, the vehicle detection instructions 1022-1, AI image processing instructions 1022-2, rule application instructions 1022-3, sensor data 1024-1, location data 1024-2, vehicle data 1024-3, and/or rules data 1024-4 may be utilized by the processor 1012 to provide output information via the output device 1036 and/or the transceiver device 1034.

According to some embodiments, the vehicle detection instructions 1022-1 may be operable to cause the processor 1012 to process sensor data 1024-1, location data 1024-2, vehicle data 1024-3, and/or rules data 1024-4 in accordance with embodiments as described herein. Sensor data 1024-1, location data 1024-2, vehicle data 1024-3, and/or rules data 1024-4 received via the input device 1032 and/or the transceiver device 1034 may, for example, be analyzed, sorted, filtered, decoded, decompressed, ranked, scored, plotted, and/or otherwise processed by the processor 1012 in accordance with the vehicle detection instructions 1022-1. In some embodiments, sensor data 1024-1, location data 1024-2, vehicle data 1024-3, and/or rules data 1024-4 may be fed by the processor 1012 through one or more mathematical and/or statistical formulas and/or models in accordance with the vehicle detection instructions 1022-1 to automatically detect, classify, and/or identify an approaching vehicle, as described herein.

In some embodiments, the AI image processing instructions 1022-2 may be operable to cause the processor 1012 to process sensor data 1024-1, location data 1024-2, vehicle data 1024-3, and/or rules data 1024-4 in accordance with embodiments as described herein. Sensor data 1024-1, location data 1024-2, vehicle data 1024-3, and/or rules data 1024-4 received via the input device 1032 and/or the transceiver device 1034 may, for example, be analyzed, sorted, filtered, decoded, decompressed, ranked, scored, plotted, and/or otherwise processed by the processor 1012 in accordance with the AI image processing instructions 1022-2. In some embodiments, sensor data 1024-1, location data 1024-2, vehicle data 1024-3, and/or rules data 1024-4 may be fed by the processor 1012 through one or more mathematical and/or statistical formulas and/or models in accordance with the AI image processing instructions 1022-2 to automatically detect, classify, and/or identify an approaching vehicle, as described herein.

According to some embodiments, the rule application instructions 1022-3 may be operable to cause the processor 1012 to process sensor data 1024-1, location data 1024-2, vehicle data 1024-3, and/or rules data 1024-4 in accordance with embodiments as described herein. Sensor data 1024-1, location data 1024-2, vehicle data 1024-3, and/or rules data 1024-4 received via the input device 1032 and/or the transceiver device 1034 may, for example, be analyzed, sorted, filtered, decoded, decompressed, ranked, scored, plotted, and/or otherwise processed by the processor 1012 in accordance with the rule application instructions 1022-3. In some embodiments, sensor data 1024-1, location data 1024-2, vehicle data 1024-3, and/or rules data 1024-4 may be fed by the processor 1012 through one or more mathematical and/or statistical formulas and/or models in accordance with the rule application instructions 1022-3 to automatically control, deploy, and/or engage or anchor autonomous and/or active vehicle barriers, as described herein.

According to some embodiments, the apparatus 1010 may comprise the cooling device 1070. According to some embodiments, the cooling device 1070 may be coupled (physically, thermally, and/or electrically) to the processor 1012 and/or to the memory device 1020. The cooling device 1070 may, for example, comprise a fan, heat sink, heat pipe, radiator, cold plate, and/or other cooling component or device or combinations thereof, configured to remove heat from portions or components of the apparatus 1010.

Any or all of the exemplary instructions and data types described herein and other practicable types of data may be stored in any number, type, and/or configuration of memory devices that is or becomes known. The memory device 1020 may, for example, comprise one or more data tables or files, databases, table spaces, registers, and/or other storage structures. In some embodiments, multiple databases and/or storage structures (and/or multiple memory devices 1020) may be utilized to store information associated with the apparatus 1010. According to some embodiments, the memory device 1020 may be incorporated into and/or otherwise coupled to the apparatus 1010 (e.g., as shown) or may simply be accessible to the apparatus 1010 (e.g., externally located and/or situated).

Data storage devices such as the memory 1020 may generally store program instructions, code, and/or modules that, when executed by a processing device cause a particular machine to function in accordance with one or more embodiments described herein. The various data storage devices described herein may be representative of a class and/or subset of computer-readable media that are defined herein as “computer-readable memory” (e.g., non-transitory memory devices as opposed to transmission devices or media).

### VI. Rules of Interpretation

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

It will be understood that various modifications can be made to the embodiments of the present disclosure herein without departing from the scope thereof. Therefore, the above description should not be construed as limiting the disclosure, but merely as embodiments thereof. Those skilled in the art will envision other modifications within the scope of the invention as defined by the claims appended hereto.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used.

Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. An autonomous vehicle barrier system, comprising:
an electronic processing device;
an electronic sensor device in communication with the electronic processing device;
an autonomous vehicle barrier comprising an orientation device coupled to a barrier element, the orientation device being in communication with the electronic processing device; and
a non-transitory memory device storing (i) threat detection logic and (ii) operating instructions that when executed by the electronic processing device, result in:
acquiring, by the electronic sensor device, data descriptive of an object;
identifying, by the electronic processing device, a rule associated with the object;
computing, by an execution of the threat detection logic by the electronic processing device, and based on an evaluation of the rule, a determination that the autonomous vehicle barrier should be deployed;
deploying, by the orientation device and in response to the computing, the barrier element.

2. The autonomous vehicle barrier system of claim 1, wherein the deploying comprises raising the barrier element to a predetermined angle with respect to a ground surface.

3. The autonomous vehicle barrier system of claim 1, further comprising:
an electronically actuated anchoring device in communication with the electronic processing device, the electronically actuated anchoring device being in further communication with at least one ground engaging device.

4. The autonomous vehicle barrier system of claim 3, wherein the operating instructions, when executed by the electronic processing device, further result in:
computing, by an execution of the threat detection logic by the electronic processing device, and based on an evaluation of the rule, a determination that the autonomous vehicle barrier should be anchored to the ground; and
propelling, by the electronically actuated anchoring device and in response to the computing of the determination that the autonomous vehicle barrier should be anchored to the ground, the at least one ground engaging device into a ground surface.

5. The autonomous vehicle barrier system of claim 3, wherein the electronically actuated anchoring device is coupled to the barrier element.

6. The autonomous vehicle barrier system of claim 3, wherein electronically actuated anchoring device comprises an explosive charge and the at least one ground engaging device comprises a metal spike.

7. The autonomous vehicle barrier system of claim 6, wherein the at least one ground engaging device is coupled to the barrier element by a cable.

8. A modular vehicle barrier, comprising:
a first ramp element coupled to a first hinge element;
a second ramp element coupled to a second hinge element; and
a first vehicle barrier frame coupled between the first and second hinge elements, the first vehicle barrier frame comprising a first barrier recess housing a first barrier element, wherein the first barrier element comprises a first plurality of bores in which first ground engaging devices are stowed, and wherein each one of the first ground engaging devices is in communication with one of a plurality of first firing units operable to propel a corresponding one of the first ground engaging devices from a respective one of the first plurality of bores.

9. The modular vehicle barrier of claim 8, further comprising:
an orientation device coupled between the vehicle barrier frame and the barrier element, the orientation device being operable to force at least a portion of the barrier element from the barrier recess.

10. The modular vehicle barrier of claim 9, further comprising:
an electronic sensor device; and
an electronic processing device in communication with the electronic sensor device, the electronic processing device being programmed to execute stored instructions to automatically engage the orientation device in response to detection of an approaching vehicle by the electronic sensor device.

11. The modular vehicle barrier of claim 10, wherein the electronic sensor device comprises one or more of a pressure sensor, a camera, a motion sensor, and a LiDAR device.

12. The modular vehicle barrier of claim 8, further comprising:
a second vehicle barrier frame coupled between the first vehicle barrier frame and the second hinge element, the second vehicle barrier frame comprising a second barrier recess housing a second barrier element, wherein the second barrier element comprises a second plurality of bores in which second ground engaging devices are stowed, and wherein each one of the second ground engaging devices is in communication with one of a plurality of second firing units operable to propel a corresponding one of the first ground engaging devices from a respective one of the second plurality of bores.

13. A portable vehicle barrier system, comprising:
a frame;
an electronic sensor device operable to detect at least one of an approaching vehicle and an impact of a vehicle with the frame;
an anchoring device coupled to the frame, the anchoring device being in communication with at least one ground engaging device and being operable, upon receipt of a triggering signal, to fire the ground engaging device into the ground; and
a triggering device in communication with the electronic sensor device, the triggering device being operable to transmit the triggering signal to the anchoring device in response to a receiving of a threat signal indicative of the at least one of the approaching vehicle and the impact of the vehicle with the frame, such threat signal being received from the electronic sensor device.

14. The portable vehicle barrier system of claim 13, wherein the electronic sensor device comprises one or more of a pressure sensor, a camera, a motion sensor, and a LiDAR device.

15. The portable vehicle barrier system of claim 13, wherein the anchoring device comprises one or more of an explosive charge, a pneumatic firing device, a firing chamber, and mechanical linkage coupled to an impact pad that is moveably coupled to the frame.
